(19) United States
(12) Patent Application Publication
(10) Pub. No.: US 2016/0190859 A1
(43) Pub. Date: Jun. 30, 2016

(54) POLICE AND SECURITY CAMERA SYSTEM UTILIZING WIRELESS ENERGY TRANSFER

(71) Applicant: PogoTec, Inc., Roanoke, VA (US)

(72) Inventors: RONALD D. BLUM, ROANOKE, VA (US); AMITAVA GUPTA, ROANOKE, VA (US); WILLIAM KOKONASKI, GIG HARBOR, WA (US); RICHARD CLOMPUS, TRINIDAD, CA (US)

(73) Assignee: PogoTec, Inc., Roanoke, VA (US)

(21) Appl. No.: 14/983,300

(22) Filed: Dec. 29, 2015

Related U.S. Application Data
(60) Provisional application No. 62/097,212, filed on Dec. 29, 2014.
(60) Provisional application No. 62/097,954, filed on Dec. 30, 2014.
(60) Provisional application No. 62/104,504, filed on Jan. 16, 2015.
(60) Provisional application No. 62/112,683, filed on Feb. 6, 2015.
(60) Provisional application No. 62/113,622, filed on Feb. 9, 2015.
(60) Provisional application No. 62/116,656, filed on Feb. 16, 2015.
(60) Provisional application No. 62/127,789, filed on Mar. 3, 2015.
(60) Provisional application No. 62/154,023, filed on Apr. 28, 2015.
(60) Provisional application No. 62/167,747, filed on May 28, 2015.
(60) Provisional application No. 62/173,754, filed on Jun. 10, 2015.
(60) Provisional application No. 62/186,297, filed on Jun. 29, 2015.
(60) Provisional application No. 62/190,857, filed on Jul. 10, 2015.

(51) Int. Cl. H02J 7/02; F41C 33/02; H04N 5/232; F41A 35/00

(52) U.S. Cl. CPC H02J 7/025; F41A 35/00; F41C 33/029; H04N 5/23241; H02J 7/345

(57) ABSTRACT

Base units, sensors, cameras, and systems and methods for wireless energy transfer are described. In an example system, a firearm holster includes a wireless energy transfer base unit configured to cause a transmitter to selectively transmit power to the firearm or a component thereof (e.g., a camera connected to the firearm) when the firearm is placed in the firearm holster.

### CROSS-REFERENCE TO RELATED APPLICATIONS

This application claims the benefit under 35 U.S.C. §119 of the earlier filing date of U.S. Provisional Application 62/097,212 entitled “POLICE SYSTEM WITH AUTOMATIC CAMERA ACTIVATION”, filed Dec. 29, 2014. The aforementioned provisional application is hereby incorporated by reference in its entirety, for any purpose.

This application claims the benefit under 35 U.S.C. §119 of the earlier filing date of U.S. Provisional Application 62/097,954 entitled “POLICE SYSTEM WITH AUTOMATIC CAMERA ACTIVATION & DISPLAY”, filed Dec. 30, 2014. The aforementioned provisional application is hereby incorporated by reference in its entirety, for any purpose.

This application claims the benefit under 35 U.S.C. §119 of the earlier filing date of U.S. Provisional Application 62/104,504 entitled “ENHANCED POLICE SYSTEM WITH AUTOMATIC CAMERA ACTIVATION & DISPLAY”, filed Jan. 16, 2015.

The aforementioned provisional application is hereby incorporated by reference in its entirety, for any purpose.

This application claims the benefit under 35 U.S.C. §119 of the earlier filing date of U.S. Provisional Application 62/112,683 entitled “POLICE AND SECURITY CAMERA SYSTEMS USING WIRELESS POWER AND ENERGY TRANSFER”, filed Feb. 6, 2015. The aforementioned provisional application is hereby incorporated by reference in its entirety, for any purpose.

This application claims the benefit under 35 U.S.C. §119 of the earlier filing date of U.S. Provisional Application 62/113,622 entitled “POLICE AND SECURITY CAMERA SYSTEMS USING HIGHLY RESONANT COUPLING”, filed Feb. 9, 2015. The aforementioned provisional application is hereby incorporated by reference in its entirety, for any purpose.

This application claims the benefit under 35 U.S.C. §119 of the earlier filing date of U.S. Provisional Application 62/116,656 entitled “ENHANCED POLICE AND SECURITY CAMERA SYSTEMS USING HIGH RESONANT COUPLING”, filed Feb. 16, 2015. The aforementioned provisional application is hereby incorporated by reference in its entirety, for any purpose.

This application claims the benefit under 35 U.S.C. §119 of the earlier filing date of U.S. Provisional Application 62/127,789 entitled “HIGHLY RESONANT COUPLED POLICE AND SECURITY CAMERA SYSTEMS”, filed Mar. 3, 2015. The aforementioned provisional application is hereby incorporated by reference in its entirety, for any purpose.

This application claims the benefit under 35 U.S.C. §119 of the earlier filing date of U.S. Provisional Application 62/154,023 entitled “POLICE AND SECURITY CAMERA SYSTEM CAPABLE OF WIRELESS ENERGY TRANSFER”, filed Apr. 28, 2015. The aforementioned provisional application is hereby incorporated by reference in its entirety, for any purpose.

This application claims the benefit under 35 U.S.C. §119 of the earlier filing date of U.S. Provisional Application 62/167,747 entitled “FURTHER ENHANCED POLICE AND SECURITY CAMERA SYSTEM CAPABLE OF WIRELESS ENERGY TRANSFER”, filed May 28, 2015. The aforementioned provisional application is hereby incorporated by reference in its entirety, for any purpose.

This application claims the benefit under 35 U.S.C. §119 of the earlier filing date of U.S. Provisional Application 62/173,754 entitled “ROBUST POLICE AND SECURITY CAMERA SYSTEM CAPABLE OF WIRELESS ENERGY TRANSFER”, filed Jun. 10, 2015. The aforementioned provisional application is hereby incorporated by reference in its entirety, for any purpose.

This application claims the benefit under 35 U.S.C. §119 of the earlier filing date of U.S. Provisional Application 62/186,297 entitled “POLICE AND SECURITY CAMERA SYSTEM UTILIZING WIRELESS ENERGY TRANSFER”, filed Jun. 29, 2015. The aforementioned provisional application is hereby incorporated by reference in its entirety, for any purpose.

This application claims the benefit under 35 U.S.C. §119 of the earlier filing date of U.S. Provisional Application 62/190,857 entitled “POLICE AND SECURITY CAMERA SYSTEM UTILIZING WIRELESS ENERGY TRANSFER COMPRISING ENERGY HARVESTING”, filed Jul. 10, 2015. The aforementioned provisional application is hereby incorporated by reference in its entirety, for any purpose.

This application hereby incorporates by reference in its entirety, for any purpose U.S. Non-Provisional Utility application Ser. No. 14/969,455, entitled “WIRELESS POWER BASE UNIT AND A SYSTEM AND METHOD FOR WIRELESSLY CHARGING DISTANCE SEPARATED ELECTRONIC DEVICES”, filed Dec. 15, 2015.

### TECHNICAL FIELD

The present disclosure relates to systems and methods for police and security cameras utilizing wireless energy transfer.

### BACKGROUND

Police and security cameras have limitations. For example, the user must remember to activate a camera for it to begin recording. If the camera is left on for a wearer's entire shift, then the amount of data to be stored, cataloged, and/or reviewed may be impractically large. In addition, during use a body camera may be pointed away from an area of interest, which may result in important information being omitted from a recording. Further, police and security officers desire electronic wearable devices that are small enough to not interfere their tasks. Existing police and security camera systems may be too bulky to be effective. There is a need for a more efficient and effective way of capturing and transmitting data (e.g., video, images, and audio) for law enforcement.

### SUMMARY

Examples of base units, systems and methods for wireless energy transfer are described. In an example, a firearm includes a camera attached to the firearm and a sensor electrically coupled to the camera and configured to detect whether the firearm is in a stored configuration. The camera may be configured to inductively receive power when the firearm is in the stored configuration. The camera may be further configured to record data responsive to the sensor detecting the firearm is not in the stored configuration. In an example, the camera is configured to cease recording data responsive to the sensor detecting that the firearm is in the stored configuration. The camera may comprise a receiver configured to receive wireless power from a distance-separated transmitter. The stored configuration may include, for example, the firearm being secured by a holster, a firearm rack, a firearm safe, or a strap. The sensor may be, for example, a UV sensor, a photosensor, a pressure sensor, or a motion sensor. The camera may be configured to harvest energy for power, for example, Wi-Fi energy, and/or radio frequency energy. In an example, the recorded data may include one or more of: image capture data, audio capture data, geo-location data, and/or time and date data.

In an example, a firearm holster includes a transmitter configured for wireless power delivery to a camera mounted on a firearm configured for placement in the firearm holster. In an example, there is a battery coupled to the transmitter and a controller coupled to the battery and the transmitter and configured to cause the transmitter to selectively transmit power from the battery to the firearm when placed in the firearm holster. In an example, the firearm holster may further include a receiver configured to receive sensed data from the camera and memory configured to store the received, sensed data.

A firearm holster, in some examples, may include a housing enclosing the transmitter, the battery, the controller, the receiver, and the memory, and wherein the housing is coupled to the firearm holster. The transmitter may comprise a coil comprising a magnetic core. The coil of the transmitter may be inductively coupled to a coil of the camera when the firearm is placed in the firearm holster. In an example, the receiver may be further configured to receive a signal from a sensor; and the controller may be further configured to cause the transmitter to selectively transmit power from the battery to the camera responsive to the received signal. In an example, the sensor is a heartrate sensor, a light sensor, a thermal sensor, an O2 sensor, a CO sensor, a CO2 sensor, an air quality sensor, a radiation sensor, or an accelerometer. In an example, the sensor is configured to detect whether the firearm is in the firearm holster.

In an example, headwear may comprise a transmitter configured for wireless power delivery to a camera mounted on the headwear. In an example, the headwear further includes a battery coupled to the transmitter and a controller coupled to the battery and the transmitter and configured to cause the transmitter to selectively transmit power from the battery to the camera. The headwear may further include a receiver configured to receive sensed data from the camera and memory configured to store the received, sensed data.

In an example, the headwear may further include a housing enclosing the transmitter, the battery, the controller, the receiver, and the memory, and wherein the housing is coupled to the headwear. The headwear may include a hat or a helmet. The coil of the transmitter may be inductively coupled to a coil of the camera. The receiver may be further configured to receive a signal from a sensor, and the controller may be configured to cause the transmitter to selectively transmit power from the battery to the camera responsive to the received signal. In an example, the sensor is a heartrate sensor, a light sensor, a thermal sensor, an O2 sensor, a CO sensor, a CO2 sensor, an air quality sensor, a radiation sensor, or an accelerometer.

In an example, a method may include receiving, at a base unit, a state of a device remote from the base unit; responsive to the state of the device, wirelessly transmitting power signals from the base unit to a camera mounted to the device; and wirelessly receiving data from the camera at the base unit. In an example, the device may be a flashlight and the state comprises the flashlight producing light. In an example, the device may be a firearm and the state comprises the firearm being away from a holster. In an example, the method may further include transmitting the data from the base unit to another party.

### BRIEF DESCRIPTION OF THE DRAWINGS

Example features, aspects and example attendant advantages of technology described herein will become apparent from the following detailed description of various embodiments, when taken in conjunction with the accompanying drawings, in which:

FIG. 1 illustrates a block diagram of a system according to examples of the present disclosure;

FIG. 2 illustrates an example of a receiving coil for an electronic device and a transmitting coil for a base unit in accordance with the present disclosure;

FIG. 3 illustrates a block diagram of a base unit according to examples of the present disclosure;

FIG. 4 illustrates a flow chart of a process according to some examples herein;

FIG. 5 illustrates a flow chart of a process according to further examples herein;

FIGS. 6A and 6B illustrate views of a base unit having a housing according to examples of the present disclosure;

FIG. 7A-C illustrate arrangements of transmitting coils of base units according to examples of the present disclosure;

FIG. 8A-C illustrate arrangements of transmitting coils of base units according to further examples of the present disclosure;

FIG. 9 illustrates a base unit in the form of a puck in accordance with further examples herein;

FIG. 10 illustrates an example transmitter and receiver configuration in accordance with the present disclosure;

FIG. 11 illustrates simulation results of wireless power transfer systems according to some examples of the present disclosure;

FIG. 12 illustrates simulation results of wireless power transfer systems according to further examples of the present disclosure;

FIG. 13 illustrates a comparison between wireless power transfer systems according to some examples of the present disclosure and Q standard systems;

FIG. 14 illustrates magnetic field lines of inductively coupled transmitting and receiving coils in accordance with some examples herein;

FIG. 15 illustrates a wireless camera system, including a base unit, a camera, and a sensor, according to some examples of the present disclosure;

FIG. 16 illustrates an example wireless camera system, including a firearm, a holster, base unit, a camera, and a sensor;

FIG. 17 illustrates an example wireless camera system, including a flashlight, a base unit, a camera, and a sensor;

FIG. 18 illustrates an example wireless camera system, including headgear, a base unit, cameras, and a sensor;

FIG. 19 illustrates an example wireless camera system, including headgear, a base unit, cameras, and a sensor;

FIG. 20 illustrates an example wireless camera system, including a user, a firearm, a holster, a flashlight, headgear, cameras, and a base unit; and

FIG. 21 illustrates a flow chart of a process of using a base unit, sensors, and a camera in accordance with further examples herein.

### DETAILED DESCRIPTION

Systems, methods and apparatuses for wirelessly powering electronic devices are described. Systems and methods in accordance with the examples herein may provide wireless power at greater distance separation between the power transmitting and receiving coils than commercially available systems. Additional advantages may be improved convenience of recording, automatic recording of important events, reduction in the amount of data to be cataloged and recorded, and other benefits as will be understood from the further description below.

According to some examples herein, a wireless camera system, and more specifically a wireless camera system utilizing wireless power transfer (e.g., a weakly resonant system with relatively broad resonance amplification with moderate frequency dependence), is described. In an example, a camera may be mounted on a firearm, a flashlight, headgear or other articles worn by law enforcement, security personnel, or others. The camera may be powered wirelessly by a remote base unit. The base unit may receive a state from a sensor (e.g., a sensor mounted on the device to which the camera is mounted) and selectively wirelessly power the camera based on the state. The camera may be configured to automatically record and transmit data when it is powered.

In accordance with some examples of wireless power transmission disclosed herein, dependence on the relative sizes of the inductive coils and orientation between the coils may be reduced as compared to such dependence on coil sizes and orientation typically found in commercially available systems with strong resonant coupling at Q factors exceeding 100. In some examples according to the present disclosure, wireless power transfer systems may operate at Q value less than 100. A Q value may be expressed as Q=1/R √(L/C) Where R is resistance, L is inductance, C is capacitance. Q may also expressed as ωₒ/2Γ, where ωₒ is frequency and Γ is a loss factor and equal to R/L.

Unlike commercially available wireless power systems, which typically use air core coils, according to some examples herein, the shape of the magnetic field between the coils may be augmented, for example by using a medium with high permeability such as ferrite. According to some examples, guided flux or partially guided flux may be used to improve the performance of the system in a given orientation. An appropriate frequency, for example a body safe frequency, is used for power broadcast. The broadcast frequency may be tuned to reduce losses that may result from shielding effects.

According to some examples herein, wireless magnetic resonance energy, resonant inductive coupling, or electromagnetic induction may refer to near field wireless transmission of electrical energy between coils that are tuned to resonate at substantially the same frequency. Resonant transfer may use a coil ring with an oscillating current to generate an oscillating magnetic field. If the coil is highly resonant, then energy placed in the coil may die away relatively slowly over very many cycles, but if a second coil is brought near it, the coil can pick up most of the energy before it is lost, even if it is some distance away. The energy received may be stored in an energy storage unit, such as a super capacitor. In an example, the super capacitor may be capable of storing electrical energy up to 15-35 watt-hour/kilogram of its weight. The stored energy can be utilized by an electronic device when required, and at a voltage required for its routine operation. In an example, the system consists of transmitters and receivers that contain magnetic loop antennas critically tuned to the same frequency. In another example, the system may include transmitters and receivers that contain magnetic loop antennas critically tuned to the same frequency. Unlike the far field wireless power transmission systems based on traveling electro-magnetic waves, examples described herein may provide for resonant inductive coupling through magnetic fields similar to those found in transformers except that the primary coil and secondary winding may be physically separated, and tuned to resonate to increase their magnetic coupling. These tuned magnetic fields generated by the primary coil can be arranged to interact vigorously with matched secondary windings in distant equipment but far more weakly with any surrounding objects or materials such as radio signals or biological tissue.

Resonant coupling may include near field resonant coupling, mid field resonant coupling, and far field resonant coupling. Near field resonant coupling may describe resonant coupling where transmitting and receiving coils are spaced apart at a distance of equal to or less than 5× the diameter of the coil. Near field may be highly efficient and may not strongly dependent upon preset angle orientation of the two coupled coils. Mid field resonant coupling may describe resonant coupling where the distance between a transmitting and receiving coil is approximately 5× to 1,000× the diameter of the coil. Mid field resonant coupling may be relatively dependent on the preset relative angular orientation of the two coupled coils. Mid-field wireless transfer of energy or electronic signals may be possible over a wide range of relative angular orientation (e.g., 40-70 degrees) and over distances of up to about 1-2 meters utilizing highly efficient magnetic resonance coupling between the receiver and the antenna with energy transfer efficiency of up to 80%. Far field resonant coupling may describe coupling where the distance between the transmitting and receiving coil is above 1,000* the diameter of the coil. Far field resonant coupling may be such that the angle orientation of the two coupled coils is not significantly important. Impedance matching of two coupled coils may be used.

High quality factor resonators enable efficient energy transfer at lower coupling rates at greater distances and with greater freedom of positioning. The highly resonant technique uses a magnetic field to transfer energy. This can also be referred to as magnetic resonance. Highly resonant wireless energy transfer or highly resonant wireless energy transfer provides the ability to transfer energy (in the form of power and/or data) over a range of distances and various positional locations and orientations. By using highly resonant coupling as opposed to conventional inductive coupling the location angle may be more forgiving. And by having multiple coils located either within the base unit or the electronic wearable device system the efficiency of the wireless energy transfer may be further improved. The mobile base unit may transfer electromagnetic power adiabatically to an electronic circuit of the electronic wearable device through inductive coupling, resonant coupling or both

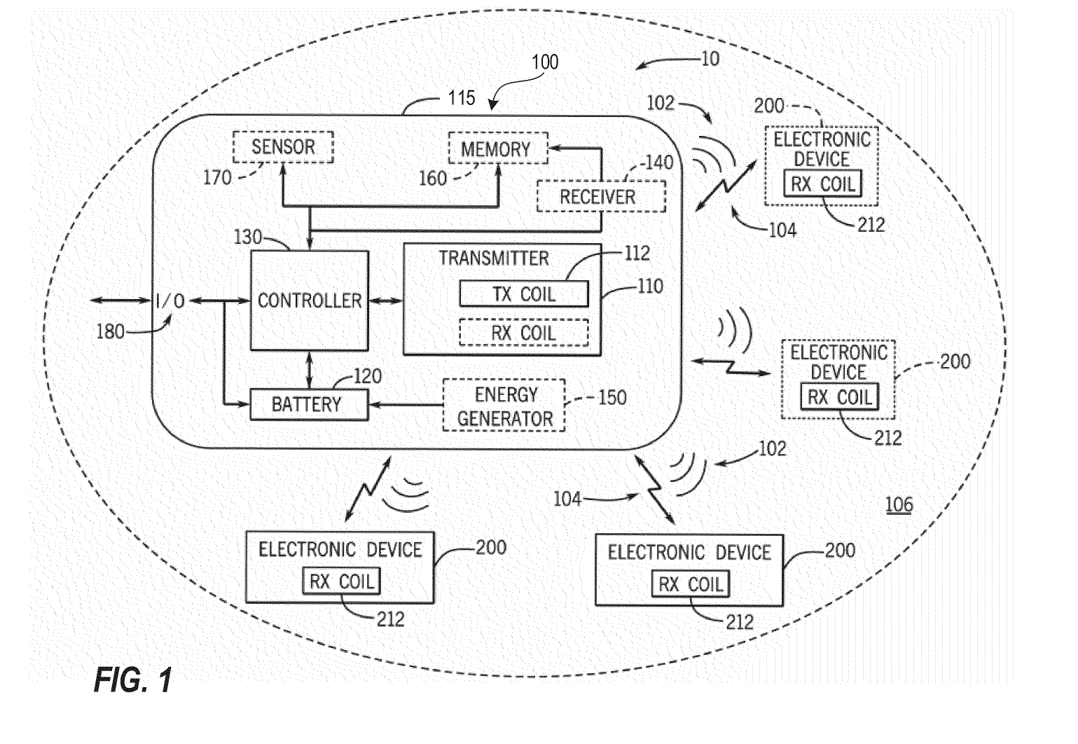

FIG. 1 shows a block diagram of a system for wirelessly powering one or more electronic devices according to some examples of the present disclosure. The system 10 includes a base unit 100 and one or more electronic devices 200. The base unit 100 is configured to wirelessly provide power to one or more of the electronic devices 200, which may be separated from the base unit by a distance. The base unit 100 is configured to provide power wirelessly to an electronic device 200 while the electronic device remains within a threshold distance (e.g., a charging range or charging zone 106) of the base unit 100. The base unit 100 may be configured to selectively transmit power wirelessly to any number of electronic devices (e.g., 1, 2, 3, 4, 5, 6, 7, 8, 9, or 10 although a greater number than 10 devices may be charged in some examples) detected to be within a proximity (e.g., within the charging range) of the base unit 100. Although the electronic device 200 may typically be charged (e.g., coupled to the base unit for charging) while being distance-separated from the base unit 100, it is envisioned and within the scope of this disclosure that the base unit 100 may operate to provide power wirelessly to an electronic device 200 when the electronic device 200 is adjacent to or in contact with the base unit 100.

The base unit 100 includes a transmitter 110, a battery 120, and a controller 130. The transmitter 110 includes at least one transmitting coil 112 (interchangeably referred to as Tx coil). The transmitting coil 112 may include a magnetic core with conductive windings. The windings may include copper wire (also referred to as copper windings). In some examples, the copper wire may be monolithic copper wire (e.g., single-strand wire). In some examples, the copper wire may be multi-strand copper wire (e.g., Litz wire), which may reduce resistivity due to skin effect in some examples, which may allow for higher transmit power because resistive losses may be lower. In some examples, the magnetic core may be a ferrite core (interchangeably referred to as ferrite rod). The ferrite core may comprise a medium permeability ferrite, for example 78 material supplied by Fair-Rite Corporation. In some examples, the ferrite core may comprise a high permeability material, such as Vitroperm 500F supplied by Vacuumschmelze in Germany. Ferrite cores comprising other ferrite materials may be used. In some examples, the ferrite may have a medium permeability of micro-i (μ) of about 2300. In some examples, the ferrite may have permeability of micro-i (μ) ranging from about 200 to about 5000. In some examples, different magnetic material may be used for the magnetic core. Generally, transmitting coils described herein may utilize magnetic cores which may in some examples shape the field provided by the transmitting coil, as the field lines preferentially go through the magnetic core, in this manner, partially guided flux may be used where a portion of the flux is guided by the magnetic core.

The transmitting coil 112 is configured to inductively couple to a receiving coil 210 in the electronic device 200. In some examples, the transmitter 110 may be additionally configured as a receiver and may thus be interchangeably referred to as transmitter/receiver. For example, the transmitting coil of the transmitter/receiver may additionally be configured as a receiving coil. In some examples, the transmitter/receiver may additionally include a receiving coil. In yet further examples, the base unit may include a separate receiver 140 comprising a receiving coil. The transmitter/receiver or separate receiver of the base unit may be configured to wirelessly receive power (102) and/or data (104) as will be further described below.

In some examples, the transmitter 110 may include a single transmitting coil 112. The transmitting coil 112 may be placed in an optimal location and/or orientation to provide an optimum charging zone 106. In some examples, the transmitting coil may be placed in a location within the base unit selected to provide a large number of charging opportunities during a typical use of the device. For example, the transmitting coil 112 may be placed near a side of the base unit which most frequently comes in proximity to an electronic device.

In some examples, the transmitter 110 includes a plurality of transmitting coils 112. The transmitting coils 112 may be arranged in virtually any pattern. For example, the base unit may include a pair of coils which are angled to one another. In some examples, the coils may be arranged at angles smaller than 90 degrees, for example ranging between 15-75 degrees. In some examples, the coils may be arranged at 45 degrees relative to one another. Other combinations and arrangements may be used, examples of some of which will be further described below.

In some examples, the transmitting coils may be arranged to provide a nearly omnidirectional charging zone 106 (also referred to as charging sphere or hotspot). The charging zone 106 of the base unit may be defined by a three dimensional space around the base unit which extends a threshold distance from the base unit in all three directions (e.g., the x, y, and z directions). Although a three dimensional (3D) space corresponding to a charging range of the base unit may be referred to herein as a sphere, it will be understood that the three dimensional (3D) space corresponding to a charging range need not be strictly spherical in shape. In some examples, the charging sphere may be an ellipsoid or a different shape.

Efficiency of wireless power transfer within the charging zone 106 may be variable, for example, depending on a particular combination of transmitting and receiving coils and/or a particular arrangement of the coils or relative arrangements of the coils in the base unit and electronic device(s). The one or more transmitting coils 112 may be arranged within a housing of the base unit in a manner which improves the omni-directionality of the charging zone 106 and/or improves the efficiency of power transmission within the zone 106. In some examples, one or more transmitting coils 112 may be arranged within the housing in a manner which increases the opportunities for charging during typical use of the base unit. For example, the transmitting coil(s) may extend, at least partially, along one or more sides of the base unit which are most brought near an electronic device (e.g., the top or sides of a mobile phone case base unit which may frequently be moved in proximity with a wearable electronic device such as eyewear camera or a digital wrist watch). In some examples, the base unit may be placed on a surface (e.g., a table or desk) during typical use and electronic devices may be placed around the base unit. In some examples, the base unit may be worn on a duty belt and charge devices arrayed alongside the base unit on the belt. In such examples, the transmitting coil(s) may be arranged along a perimeter of the base unit housing. In other examples the base unit may be integrated with or attached to a holster and configured to charge devices attached to a firearm inserted therein. In such examples, the transmitting coil(s) may be arranged along a back side of the base unit.

In some examples, the base unit may be attached to an article or device via an attachment mechanism such as adhesive attachment, an elastic attachment, a spring clamp, suction cup(s), mechanical pressure, or others. The article or device to which the base unit may be attached may include but need not be limited to: a mobile phone, a belt, a holster, headgear, a flashlight, a hat, eyewear, a helmet, a belt, a strap, a coat, a hair clip, a tie, a tie clip, a button, a shirt, a car dash board, a vehicle dash board, a vehicle, an air craft, a wrist watch, a wrist band, a necklace, an ear ring, a ring, a shoe. In some examples, the base unit may be enclosed or embedded in an enclosure (also referred to as housing), which may have a generally planar shape (e.g., a rectangular plate). In some examples, the base unit may be enclosed or embedded in an enclosure having a shape corresponding to the article to which it is intended to be attached. An attachment mechanism may be coupled to the housing such that the base unit may be removably attached to an article or device. In an example, the attachment mechanism may be a biasing member, such as a clip, which is configured to bias the article or device towards the base unit in the form of, by way of example only, a rectangular plate. For example, a clip may be provided proximate a side of the base unit and the base unit may be attached to (e.g., clipped to) a mobile phone via the clip in a manner similar to attaching paper or a notebook/notepad to a clip board. In some examples, the base unit may be adhesively or elastically attached to the article or device.

In further examples, the base unit may be separate from the article or device. In yet further examples, the base unit may be incorporated into (e.g., integrated into) the article or device. For example, the transmitter 110 may be integrated with other components of a typical mobile phone, radio, walkie-talkie, or other device. In another example, the transmitter 110 may be integrated into a brim of a hat or other article. The controller 130 may be a separate IC in a device or its functionality may be incorporated into the processor and/or other circuitry of the device. Typical mobile phones, flashlights, radios, and walkie-talkies include a battery (e.g., a rechargeable battery) which may also function as the battery 120 of the base unit. In this manner, an article or device may be configured to provide power wirelessly to electronic devices, such as a separated electronic wearable devices.

As previously noted, the base unit 100 may include a battery 120. The battery 120 may be a rechargeable battery, such as a Nickel-Metal Hydride (NiMH), a Lithium ion (Li-ion), or a Lithium ion polymer (Li-ion polymer) battery. The battery 120 may be coupled to other components to receive power. In an example, the battery 120 may be charged by a security vehicle. In another example, the battery 120 may be coupled to an energy generator 150. The energy generator 150 may include an energy harvesting device which may provide harvested energy to the battery for storage and use in charging the electronic device(s). Energy harvesting devices may include, but not be limited to, kinetic-energy harvesting devices, solar cells, thermoelectric generators, or radio-frequency harvesting devices. In some examples, the battery 120 may be coupled to an input/output connector 180 such as a universal serial bus (USB) port. It will be understood that the term USB port herein includes any type of USB interface currently known or later developed, for example mini and micro USB type interfaces. Other types of connectors, currently known or later developed, may additionally or alternatively be used. The I/O connector 180 (e.g., USB port) may be used to connect the base unit 100 to an external device, for example an external power source or a computing device (e.g., a computer, laptop, tablet, or a mobile phone). The base unit 100 may be or also act as an auxiliary battery pack for one or more devices. In an example, the base unit 100 does not comprise a battery or does not comprise a battery as a primary power source. In an example, the battery 120 may be remote from the base unit (e.g., outside of a housing of the base unit). In an example, the base unit 100 comprises a port configured to receive power from a power source.

The transmitter 110 is operatively coupled to the battery 120 to selectively receive power from the battery and wirelessly transmit the power to the electronic device 200. As described herein, in some examples, the transmitter may combine the functionality of transmitter and receiver. In such examples, the transmitter may also be configured to wirelessly receive power from an external power source. It will be understood that during transmission, power may be wirelessly broadcast by the transmitter and may be received by any receiving devices within proximity (e.g., within the broadcast distance of the transmitter).

The transmitter 110 may be tightly- or weakly-coupled to a receiver in the electronic device 200 in some examples. Depending on the distance between the transmitter 110 and the electronic device 200, there may or may not be a tight coupling between the transmitter 110 and the receiver in the electronic device 200. Highly resonant coupling may be considered tight coupling. The weak (or loose) coupling may allow for power transmission over a distance (e.g. from a base unit on a duty belt to a wearable device held in a user's hand or from a base unit placed on a surface to a wearable device placed on the surface in a neighborhood of, but not on, the base unit). So, for example, the transmitter 110 may be distance separated from the receiver. The distance may be less than 1 mm in some examples, greater than 1 mm in some examples, greater than 10 mm in some examples, greater than 100 mm in some examples, and greater than 1000 mm in some examples. Other distances may be used in other examples, and power may be transferred over these distances. The transmitter 110 and the receiver in the electronic device 200 may be, at times, weakly coupled and, at other times, may be strongly coupled.

The transmitter 110 and the receiver in the electronic device 200 may include impedance matching circuits each having an inductance, capacitance, and resistance. The impedance matching circuits may function to adjust impedance of the transmitter 110 to better match impedance of a receiver under normal expected loads, although in examples described herein the transmitter and receiver may have transmit and receive coils, respectively, with different sizes and/or other characteristics such that the impedance of the receiver and transmitter may not be matched by the impedance matching circuits, but the impedance matching circuits may reduce a difference in impedance of the transmitter and receiver. The transmitter 110 may generally provide a wireless power signal which may be provided at a body-safe frequency, e.g. less than 500 kHz in some examples, less than 300 kHz in some examples, less than 200 kHz in some examples, between 75 kHz and 175 kHz in some examples, 125 kHz in some examples, less than 100 kHz in some examples, although other frequencies may be used. In some examples, the frequency may be within the range of 100 kHz and 1 GHz, 1 kHz and 1 GHz, and 100 kHz and 10 GHz. In another example, the frequency may be within the range of 1 MHz and 1 GHz. In another example, the frequency modulation may be 13.6 MHz+/−5%.

Transmission/broadcasting of power may be selective in that a controller controls when power is being broadcast. The base unit may include a controller 130 coupled to the battery 120 and transmitter 110. The controller 130 may be configured to cause the transmitter 110 to selectively transmit power, as will be further described. A charger circuit may be connected to the battery 120 to protect the battery from overcharging. The charger circuit may monitor a level of charge in the battery 120 and turn off charging when it detects that the battery 120 is fully charged. The functionality of the charger circuit may, in some examples, be incorporated within the controller 130 or it may be a separated circuit (e.g., separate IC chip).

In some examples, the base unit may include a memory 160. The memory 160 may be coupled to the transmitter 110 and/or any additional transmitters and/or receivers (e.g., receiver 140) for storage of data transmitted to and from the base unit 100. For example, the base unit 100 may be configured to communicate data wirelessly to and from the electronic device 200. For example, the base unit may receive images, audio, and/or video acquired with an electronic device), and/or transmit configuration data to the electronic device. The base unit may include one or more sensors 170, which may be operatively coupled to the controller. A sensor 170 may detect a status of the base unit such that the transmitter may provide power selectively and/or adjustably under control from controller 130. A sensor 170 may detect a status or state outside of the base unit, such as an external temperature, a heart rate of a user, and/or other statuses or states. In some examples, the base unit may further comprise a microphone, an audio recorder, an audio playback unit.

The electronic device 200 may be configured to provide virtually any functionality, for example an electronic device configured as a wearable camera, an electronic watch, electronic band, and other such smart devices. In addition to circuitry adapted to perform the specific function of the electronic device, the electronic device 200 may further include circuitry associated with wireless charging. The electronic device 200 may include at least one receiving coil 212, which may be coupled to a rechargeable power cell onboard the electronic device 200. Frequent charging in a manner that is non-invasive or minimally invasive to the user during typical use of the electronic device may be achieved via wireless coupling between the receiving and transmitting coils in accordance with the examples herein.

In some examples, the electronic device may be a wearable electronic device, which may interchangeably be referred to herein as electronic wearable devices. The electronic device may have a sufficiently small form factor to make it easily portable by a user. The electronic device 200 may be attachable to clothing, an accessory worn by the user (e.g., eyewear or headgear), or an article or device carried by the user (e.g., a firearm or a flashlight). For example, the electronic device 200 may be attached to eyewear using a guide 6 (e.g., track) incorporated in the eyewear. In some examples, the electronic device 200 may be a miniaturized camera system which may, in some examples, be attached to a firearm. In other examples, the electronic device may be any other type of an electronic system, such as an image display system, an air quality sensor, a UV/HEV sensor, a pedometer, a night light, a blue tooth enabled communication device such as blue tooth headset, a hearing aid or an audio system. In some examples, the electronic device may be worn on the body, for example around the wrist (e.g., an electronic watch or a biometric device, such as a pedometer). The electronic device 200 may be another type of electronic device other than the specific examples illustrated. The electronic device 200 may be virtually any miniaturized electronic device, for example and without limitation a camera, image capture device, IR camera, still camera, video camera, image sensor, repeater, resonator, sensor, sound amplifier, directional microphone, eyewear supporting an electronic component, spectrometer, directional microphone, microphone, camera system, infrared vision system, night vision aid, night light, illumination system, sensor, pedometer, wireless cell phone, mobile phone, wireless communication system, projector, laser, holographic device, holographic system, display, radio, GPS, data storage, memory storage, power source, speaker, fall detector, alertness monitor, geo-location, pulse detection, gaming, eye tracking, pupil monitoring, alarm, CO sensor, CO detector, CO2 sensor, CO2 detector, air particulate sensor, air particulate meter, UV sensor, UV meter, IR sensor IR meter, thermal sensor, thermal meter, poor air sensor, poor air monitor, bad breath sensor, bad breath monitor, alcohol sensor, alcohol monitor, motion sensor, motion monitor, thermometer, smoke sensor, smoke detector, pill reminder, audio playback device, audio recorder, speaker, acoustic amplification device, acoustic canceling device, hearing aid, assisted hearing assisted device, informational earbuds, smart earbuds, smart ear-wearables, video playback device, video recorder device, image sensor, fall detector, alertness sensor, alertness monitor, information alert monitor, health sensor, health monitor, fitness sensor, fitness monitor, physiology sensor, physiology monitor, mood sensor, mood monitor, stress monitor, pedometer, motion detector, geo-location, pulse detection, wireless communication device, gaming device, eyewear comprising an electronic component, augmented reality system, virtual reality system, eye tracking device, pupil sensor, pupil monitor, automated reminder, light, alarm, cell phone device, phone, mobile communication device, poor air quality alert device, sleep detector, doziness detector, alcohol detector, thermometer, refractive error measurement device, wave front measurement device, aberrometer, GPS system, smoke detector, pill reminder, speaker, kinetic energy source, microphone, projector, virtual keyboard, face recognition device, voice recognition device, sound recognition system, radioactive detector, radiation detector, radon detector, moisture detector, humidity detector, atmospheric pressure indicator, loudness indicator, noise indicator, acoustic sensor, range finder, laser system, topography sensor, motor, micro motor, nano motor, switch, battery, dynamo, thermal power source, fuel cell, solar cell, kinetic energy source, thermo electric power source, smart band, smart watch, smart earring, smart necklace, smart clothing, smart belt, smart ring, smart bra, smart shoes, smart footwear, smart gloves, smart hat, smart headwear, smart eyewear, and other such smart devices. In some examples, one or more of the listed components may be integrated into the base unit. In some examples, the electronic device 200 may be a smart device. In some examples, the electronic device 200 may be a micro wearable device or an implanted device.

The electronic device 200 may include a receiver (e.g., Rx coil 212) configured to inductively couple to the transmitter (e.g., Tx coil 112) of the base unit 100. The receiver may be configured to automatically receive power from the base unit when the electronic device and thus the receiver is within proximity of the base unit (e.g., when the electronic device is a predetermined distance, or within a charging range, from the base unit). The electronic device 200 may store excess power in a power cell onboard the electronic device. The power cell onboard the electronic device may be significantly smaller than the battery of the base unit. Frequent recharging of the power cell may be effected by virtue of the electronic device frequently coming within proximity of the base unit during normal use. For example, in the case of a wearable electronic device coupled to eyewear and a base unit in the form of a cell phone case, during normal use, the cell phone may be frequently brought to proximity of the user's head to conduct phone calls during which times recharging of the power cell onboard the wearable electronic device may be achieved. As another example, a firearm with a mounted electronic device may, during normal use, be located in a holster, which may include a base unit for wirelessly recharging an electronic device of the firearm. In some examples, in which the wearable electronic device comprises an electronic watch or biometric sensor coupled to a wrist band or an arm band, the wearable electronic device may be frequently recharged by virtue of the user reaching for their cellphone and the base unit in the form of a cell phone case coming within proximity to the wearable electronic device. In some examples, the electronic device may include an energy harvesting system.

In some examples, the electronic device 200 may not include a battery and may instead be directly powered by wireless power received from the base unit 100. In some examples, the electronic device 200 may include a capacitor (e.g., a supercapacitor or an ultracapacitor) operatively coupled to the Rx coil 212.

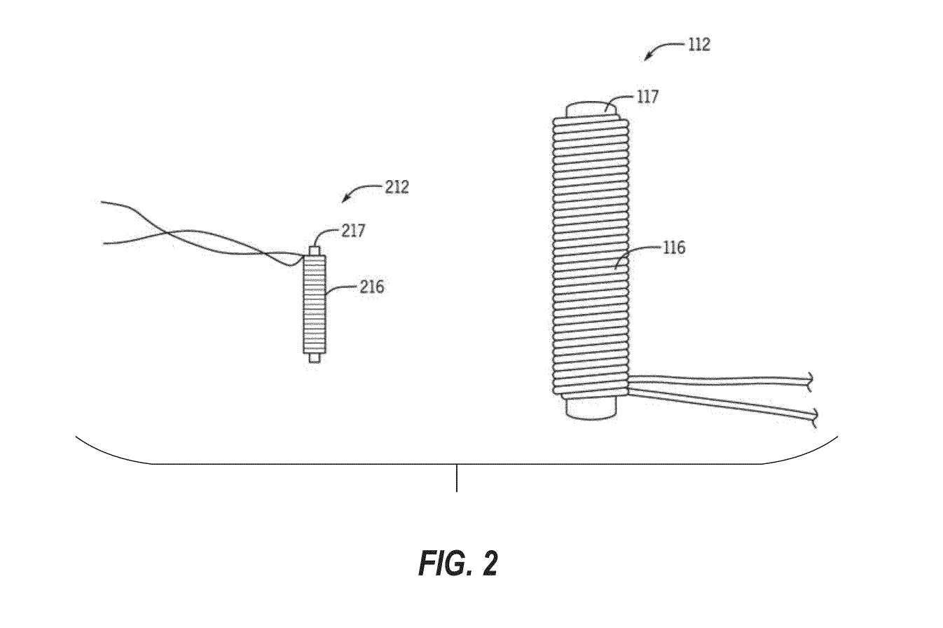

Typically in existing systems which apply wireless power transfer, transmitting and receiving coils may have the same or substantially the same coil ratios. However, given the smaller form factor of miniaturized electronic devices according to the present disclosure, such implementation may not be practical. In some examples herein, the receiving coil may be significantly smaller than the transmitting coils, e.g., as illustrated in FIG. 2. In some examples, the Tx coil 112 may have a dimension (e.g., a length of the wire forming the windings 116, a diameter of the wire forming the windings 116, a diameter of the coil 112, a number of windings 116, a length of the core 117, a diameter of the core 117, a surface area of the core 117) which is greater, for example twice or more, than a respective dimension of the Rx coil 212 (e.g., a length of the wire forming the windings 216, a diameter of the coil 212, a number of windings 216, a length of the core 217, a surface area of the core 217). In some examples, a dimension of the Tx coil 112 may be two times or greater, five times or greater, ten times or greater, twenty times or greater, or fifty times or greater than a respective dimension of the Rx coil 212. In some examples, a dimension of the Tx coil 112 may be up to 100 times a respective dimension of the Rx coil 212. For example, the receiving coil 212 (Rx coil) may comprise conductive wire having wire diameter of about 0.2 mm. The wire may be a single strand wire. The Rx coil in this example may have a diameter of about 2.4 mm and a length of about 13 mm. The Rx coil may include a ferrite rod having a diameter of about 1.5 mm and a length of about 15 mm. In an example, the length of a transmitting coil 112 (Tx coil) can be longer than the receiving coil 212 (Rx coil) if the coil of the transmitting coil 112 (Tx coil) is thicker than the coil of the receiving coil 212 (Rx coil). In another example, the transmitting coil 112 (Tx coil) and the receiving coil 212 (Rx coil) may have substantially the same length, number of windings, and thickness. The number of windings in the Rx coil may be, by way of example only, approximately 130 windings. The transmitting coil 112 (Tx coil) may comprise a conductive wire having a wire diameter of about 1.7 mm. The wire may be a multi-strand wire. The Tx coil in this example may have a diameter of about 14.5 mm and a length of about 67 mm. The Tx coil may include a ferrite rod having a diameter of about 8 mm and a length of about 68 mm. Approximately 74 windings may be used for the Tx coil. Other combinations may be used for the Tx and Rx coils in other examples, e.g., to optimize power transfer efficiency even at distances in excess of approximately 30 cm or more. In some examples, the transfer distance may exceed 12 inches. In some examples herein, the Tx and Rx coils may not be impedance matched, as may be typical in conventional wireless power transfer systems. Thus, in some examples, the Tx and Rx coils of the base unit and electronic device, respectively, may be referred to as being loosely-coupled. According to some examples, the base unit is configured for low Q factor wireless power transfer. For example, the base unit may be configured for wireless power transfer at Q factors less than 500 in some examples, less than 250 in some examples, less than 100 in some examples, less than 80 in some examples, less than 60 in some examples, and other Q factors may be used. While impedance matching is not required, examples in which the coils are at least partially impedance matched are also envisioned and within the scope of this disclosure. While the Tx and Rx coils in wireless powers transfer systems described herein may be typically loosely coupled, the present disclosure does not exclude examples in which the Tx and Rx coils are impedance matched.

The receiving coil (e.g., Rx coil 212) may include conductive windings, for example copper windings. Conductive materials other than copper may be used. In some examples, the windings may include monolithic (e.g., single-strand) or multi-strand wire. In some examples, the length of the metal that makes up the coil can range between 1 cm and 300 cm. In some examples, the coil can be in the form of a rectangle, oval, circle, square and/or any other shape. In some examples, the core may be a magnetic core which includes a magnetic material such as ferrite. The core may be shaped as a rod. The Rx coil may have a dimension that is smaller than a dimension of the Tx coil, for example a diameter, a length, a surface area, and/or a mass of the core (e.g., rod) may be smaller than a diameter, a length, a surface area, and/or a mass of the core (e.g., rod) of the Tx coil. In some examples, the magnetic core (e.g., ferrite rod) of the Tx coil may have a surface area that is two greater or more than a surface area of the magnetic core (e.g., ferrite rod) of the Rx coil. In some examples, the Tx coil may include a larger number of windings and/or a greater length of wire in the windings when unwound than the number or length of wire of the windings of the Rx coil. In some examples, the length of unwound wire of the Tx coil may be at least two times the length of unwound wire of the Rx coil.

A diameter ø of the Tx coils may range from about 5 mm to about 20 mm. In some examples, the diameter ø of the Tx coils may be between 8 mm to 15 mm. In some examples, the diameter ø of the Tx coils may be 9 mm, 10 mm, 11 mm, 12 mm, 13 mm, or 14 mm. Different diameters for the coils may be used. The magnetic cores in this example are implemented as elongate cylindrical rods made from a magnetic material. The rods in this example are arranged around the perimeter of the base unit 1100. In some examples, the rods may extend substantially along the full length of the top side, bottom side, left and right sides of a housing of the base unit.

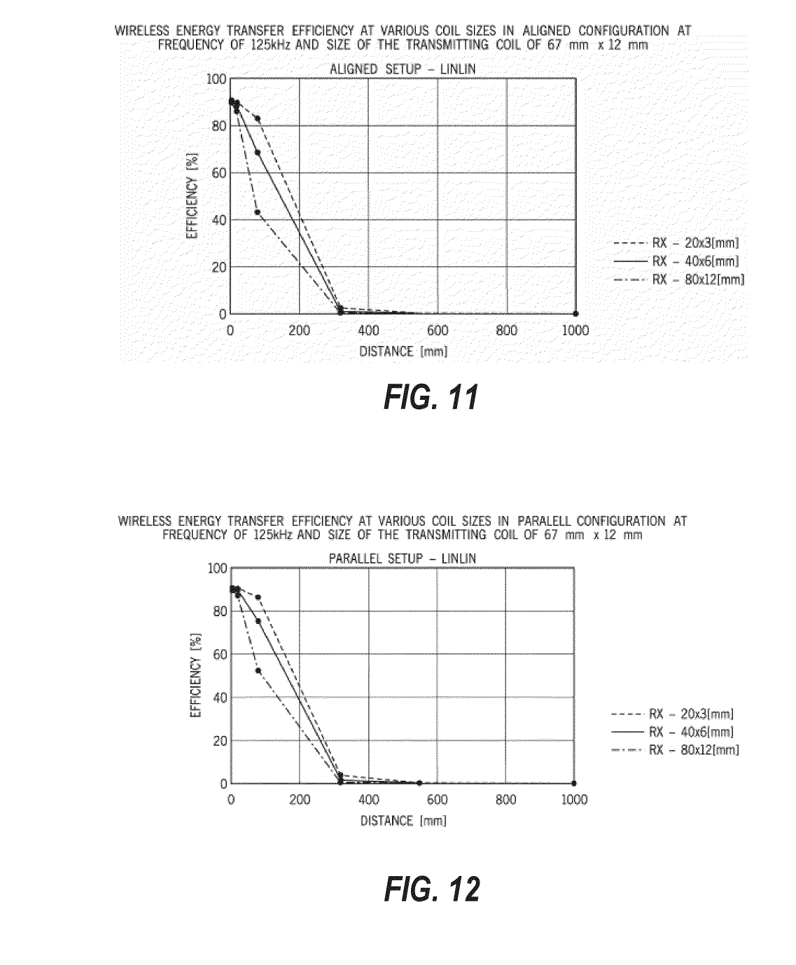

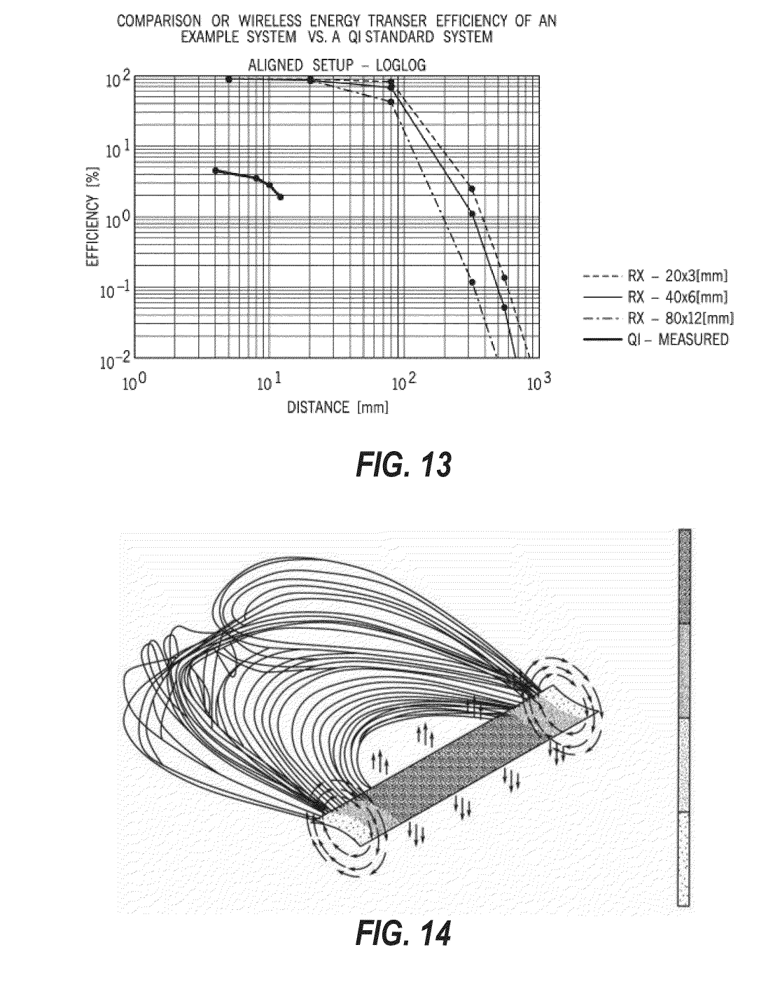

In some examples, an Rx coil 212 may have a length from about 10 mm to about 90 mm and a radius from about 1 mm to about 15 mm. In one example, the performance of an Rx coil 212 having a ferrite rod 20 mm in length and 2.5 mm in diameter with 150 conductive windings wound thereupon was simulated with a Tx coil 112 configured to broadcast power at frequency of about 125 kHz. The Tx coil 112 included a ferrite rod having a length of approximately 67.5 mm and a diameter of approximately 12 mm. The performance of the coils was simulated in an aligned orientation in which the coils were coaxial and in a parallel orientation in which the axes of the coils were parallel to one another, and example results of simulations performed are shown in FIGS. 11 and 12. Up to 20% transmission efficiency was obtained in the aligned orientation at distances of up to 200 mm between the coils. Some improvement was observed in the performance when the coils were arranged in a parallel orientation, in which the Rx coil continued to receive transmitted power until a distance of about 300 mm. Examples of a wireless energy transfer system according to the present disclosure were compared with efficiency achievable by a system configured in accordance with the Qi 1.0 standard. The size of the Tx coil in one simulated system was 52 mm×52 mm×5.6 mm and a size of one Rx coil simulated was 48.2 mm×32.2 mm×1.1 mm, and load impedance was 1 KOhm. Simulations were performed in an aligned configuration with several Rx coil sizes, and example results of simulations performed are shown in FIG. 13.

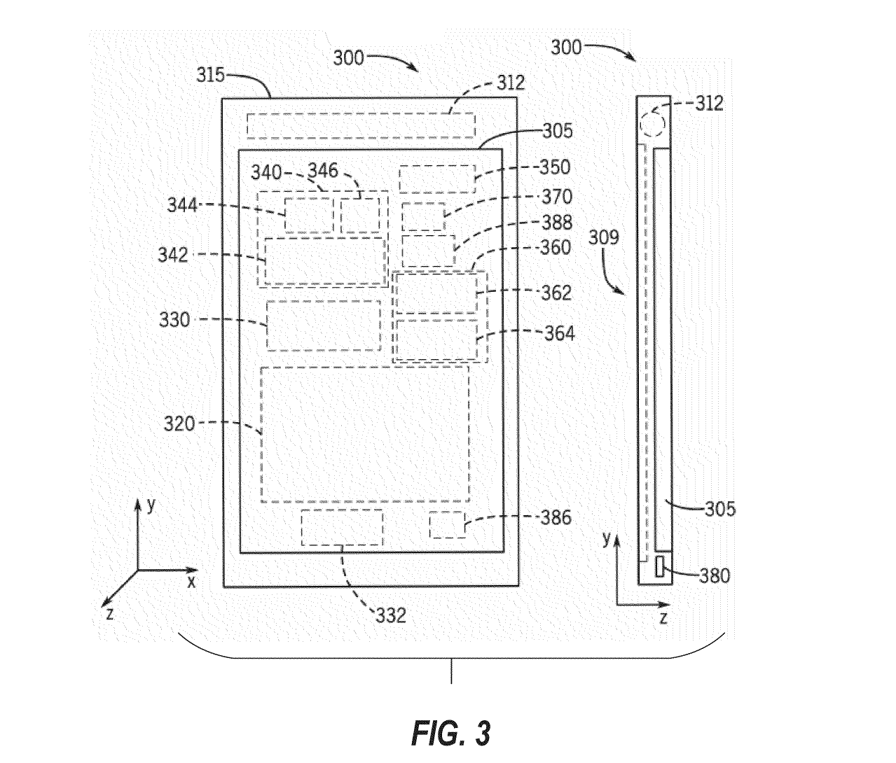

Referring now also to FIG. 3, an example base unit 300 will be described. The base unit 300 may include some or all of the components of base unit 100 described above with reference to FIG. 1. For example, the base unit 300 may include a transmitting coil 312 (also referred to as Tx coil). The transmitting coil 312 is coupled to an electronics package 305, which includes circuitry configured to perform the functions of a base unit in accordance with the present disclosure, including selectively and/or adjustably providing wireless power to one or more electronic devices. In some examples, the electronic device may be an electronic device which is separated from the base unit.

The base unit 300 may provide a mobile wireless hotspot (e.g., charging sphere 106) for wirelessly charging electronic devices that are placed or come into proximity of the base unit (e.g., within the charging sphere). In an example, the base unit 300 may be implemented in the form of a firearm holster that may be worn on a duty belt of a user, thus making the hotspot of wireless power mobile and available to electronic devices carried by the user. As will be further appreciated, opportunities for recharging the power cell on an electronic device worn by the user are frequent during normal wearing of a duty belt, which may carry a number of electronic devices for the wearer, including a cell phone, radio, walkie-talkie, flashlight, and other devices.

In examples, the base unit 300 may be integrated with or carried on a security or law enforcement officer's duty belt. The hotspot of wireless power by virtue of being connected to the user's duty belt, which the office often or always carries with him or her, thus advantageously travels with the user. In another example, the base unit 300 may be implemented in the form of a mobile phone case that may be attached to a mobile phone and carried by the user, thus making the hotspot of wireless power mobile and available to electronic devices wherever the user goes. In examples, the base unit 300 may be integrated with a mobile phone. As will be further appreciated, opportunities for recharging the power cell on an electronic device worn by the user are frequent during the normal use of the mobile phone, which by virtue of being use may frequently be brought into the vicinity of wearable devices (e.g., eyewear devices when the user is making phone calls, wrist worn devices when the user is browsing or using other function of the mobile phone).

The Tx coil 312 and electronics (e.g., electronics package 305) may be enclosed in a housing 315. The housing 315 may have a portable form factor. In this example, the housing is implemented in the form of an attachment member configured to be attached to a device or article. In some examples, the device may be a mobile communication device, such as a mobile phone, a cellular phone, a smart phone, a two-way radio, a tablet, a walkie-talkie, and the like. In further examples, the housing of the base unit may be implemented as an attachment member adapted to be attached to or integrated into an article, such as a belt, strap, holster, headgear, headwear, eyewear, clothing, smart clothing or others. The housing 315 may include features for mechanically engaging the device or article. Lengths (l), widths (w), and thicknesses (t) of the housing 315 may range from about 150-180 mm, 80-95 mm, and 15-25 mm, respectively. Other lengths, widths, and thicknesses may be used, e.g., to accommodate a given article or device and/or accommodate a particular coil size. In further examples, the housing may be configured to provide or contribute to one or more of: water resistance, moisture resistance, sweat resistance, dust resistance, shock resistance, drop resistance, water proofing and/or other characteristics of the base unit.

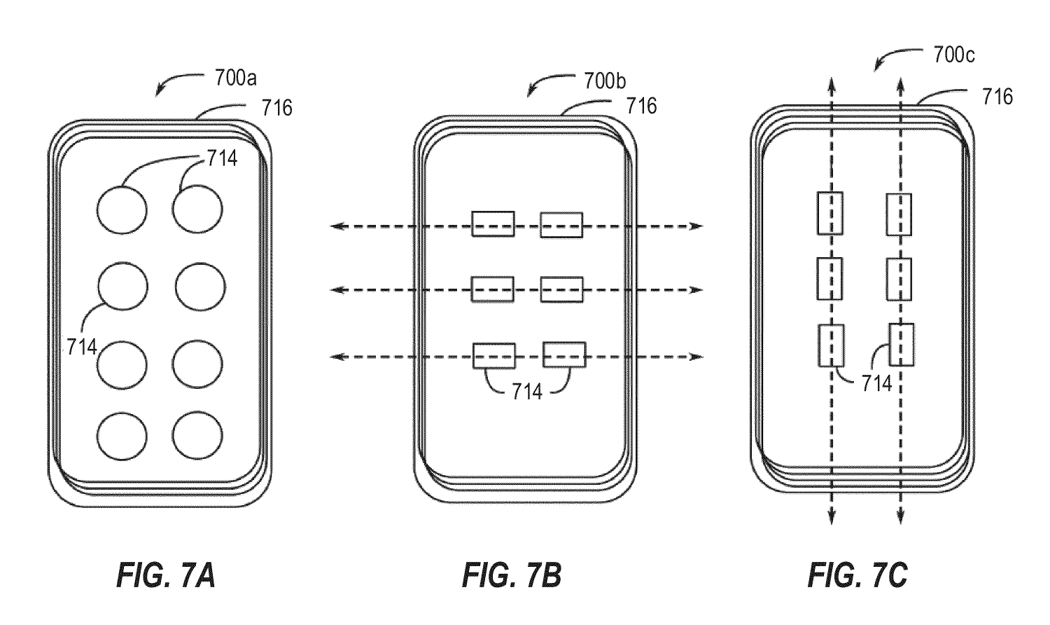

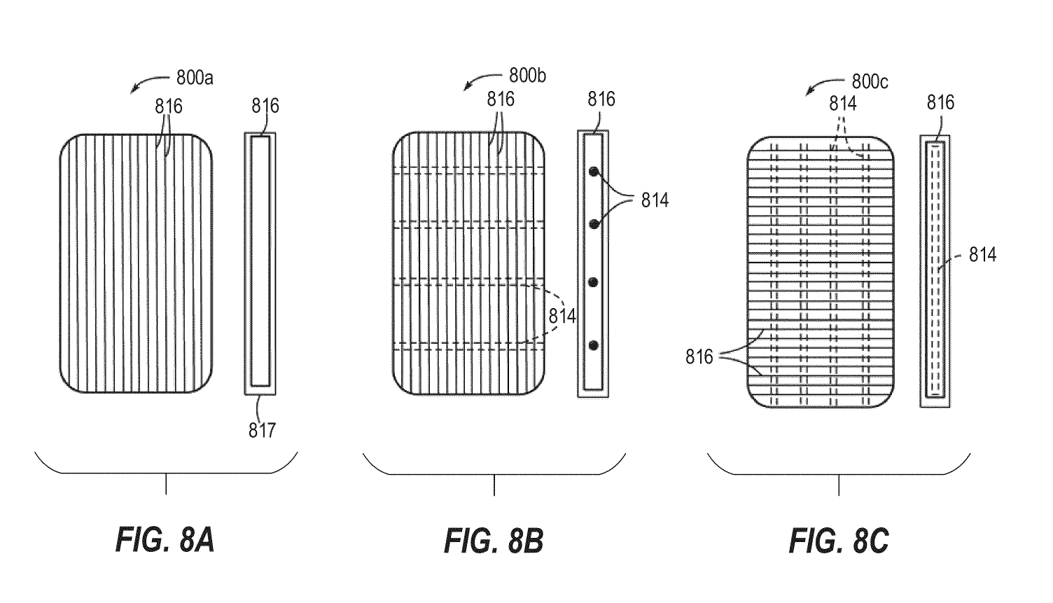

In example in FIG. 2, the base unit 300 includes a transmitting coil 312. The transmitting coil 312 may include a magnetic core with conductive windings. The core may be made of a ferromagnetic material (e.g., ferrite), a magnetic metal, or alloys or combinations thereof, collectively referred to herein as magnetic material. For example, a magnetic material such as ferrite and various alloys of iron and nickel may be used. The coil 312 includes conductive windings 316 provided around the core. It will be understood in the context of this disclosure that the windings may be, but need not be, provided directly on the core. In other words, the windings may be spaced from the core material which may be placed within a space defined by the windings, as will be described with reference to FIGS. 7-8. In some examples, improved performance may be achieved by the windings being wound directly onto the core as in the present example.

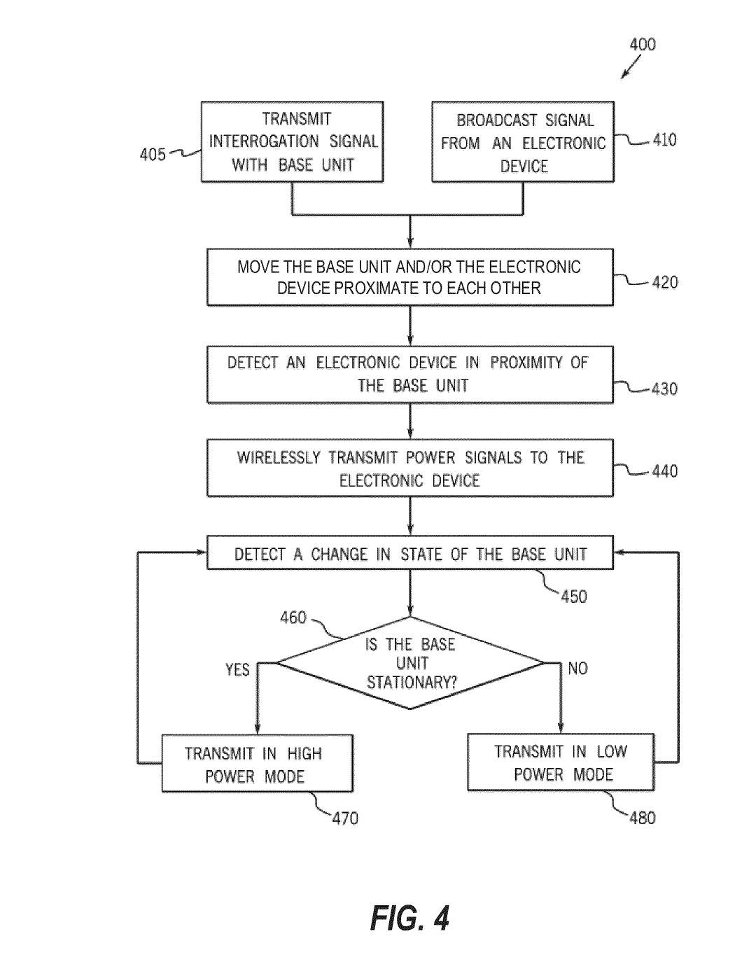

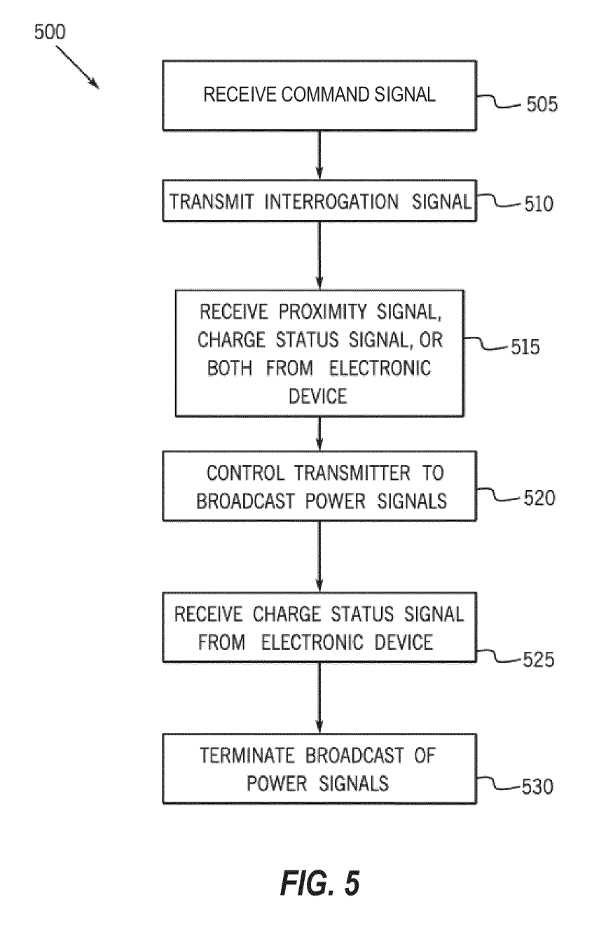

The core may be shaped as an elongate member and may have virtually any cross section, e.g., rectangular or circular cross section. An elongate core may interchangeably be referred to as a rod, e.g., a cylindrical or rectangular rod. The term rod may be used to refer to an elongate core in accordance with the present application, regardless of the particular cross sectional shape of the core. The core may include a single rod or any number of discrete rods (e.g., 2, 3, 4, 5, 6, 7, 8, 9, 10 or any other number greater than 10) arranged in patterns as will be described. In the examples in FIGS. 4 and 5, without limitation, the transmitting coil comprises a single cylindrical rod positioned at least partially along a first side (e.g., top side) of the housing 315. In other examples, one or more coils may alternatively or additionally be positioned along other sides, e.g., a bottom side, a left side and/or a right side of the housing 315.

The electronics package 305 (interchangeably referred to as electronics or circuitry) may be embedded in the housing 315 or provided behind a cover, which may be removable. In some examples, it may be advantageous to replace the battery 320. In such examples, the battery 320 may be a separable component from the remaining circuitry. The battery 320 may be accessed by removing the cover. In some examples, the electronics package 305 may include a battery for storing energy from an external power source. In some examples, the base unit 300 may alternatively or additionally receive power from the mobile phone when powering the distance separated electronic device. In some examples, the base unit may not require a battery, and even smaller form factors may thus be achieved.

The base unit may be provided with one or more I/O devices 380. I/O devices may be used to receive and/or transmit power and/or data via a wired connection between the base unit and another device. For example, the base unit may include an I/O device 380 in the form of a USB connector. The I/O device 380 (e.g., USB connector) may include a first connection side (e.g., a female port) for coupling the base unit to external devices (e.g., a power source such as the power grid and/or another electronic device). The I/O device 380 may include a second connection side (e.g., a male connector) for coupling the base unit to external devices (e.g., a mobile phone, a portable hard drive, a memory card, and/or another electronic device).

The base unit 300 may include a controller 330. The controller may include functionality for controlling operations of the base unit, for example controlling detection of electronic devices within proximity, selective transmission of wireless power upon detection of an electronic device, determination of status of the base unit, and selection of transmission mode depending on the status of the base unit. These functions may be implemented in computer readable media or hardwired into ASICs or other processing hardware. The controller may interchangeably be referred to as base unit processor.

The base unit may include one or more memory devices 360. The base unit may include volatile memory 362 (e.g., RAM) and non-volatile memory 364 (e.g., EEPROM, flash or other persistent electronic storage). The base unit may be configured to receive data (e.g. user data, configuration data, video data, image data, audio data, sensor data) through wired or wireless connection with external electronic devices and may store the data on board the base unit (e.g., in one or more of the memory devices 360). The base unit may be configured to transmit data stored onboard the base unit to external electronic devices as may be desired. For example, the base unit may transmit stored data to another party (e.g., a remote backup site or a reviewer). In another example, the base unit may relay received data to another party with or without storing the data onboard the base unit. In addition to user data, the memory devices may store executable instructions which, when executed by a processor (e.g., processor 330), cause the base unit to perform functions described herein.

The base unit 300 may include a charger circuit 332, which may be configured to protect the battery 320 from overcharging. The charger circuit may be a separate chip or may be integrated within the controller 330. The base unit may include a separate transmitter/receiver circuitry 340 in addition to the Tx coil 312 used for wireless power transmission. The transmitter/receiver circuitry 340 may include a receiving/transmitting coil 342, e.g., an RF coil. The transmitter/receiver circuitry 340 may further include driver circuitry 344 for transmission (e.g., RF driver circuit) and sense circuitry 346 for reception of signals (e.g., RF sensing circuit). The base unit 300 may include additional circuitry for wireless communication (e.g., communication circuit 388). The communication circuit 388 may include circuitry configured for Bluetooth, Wi-Fi, cellular, LTE, and/or other wireless communication. In some examples, a coil of the base unit 300 (e.g., coil 312 or 342) may function as an antenna or a receiver. In some examples, the base unit 300 may include one or more sensor 370 and/or one or more energy generators 350 as described herein. Additional circuitry providing additional functionality may be included. For example, the base unit 300 may include an image, video, and/or audio processor for processing and/or enhancement of images, video, and/or audio received from a wearable or mountable camera or microphone. In an example, image processing functionality may be provided in a separate integrated circuit (e.g., a DaVinci chip set by Texas Instruments) or it may be incorporated in a processor which implements the functions of controller 330.

In some examples, the housing 315 may be configured to receive or be coupled to a device or article. For example, a housing may be configured to provide the functionality of a firearm holster and may be configured to receive a firearm. For example, the housing may have an opening into which a firearm may be received. The housing may include engagement features for securing the firearm. One or more coils of the base unit may be placed along a length of the holster and/or around the perimeter of the holster, e.g. along any of the top, bottom, or left and right sides. In some examples, the housing 315 may be configured to be mechanically coupled to an article of clothing, such as a duty belt. In other examples, the housing 315 may be configured to receive a flashlight, baton, chemical spray, or other device or article.

With reference now also to FIGS. 4 and 5, operations of a base unit in accordance with some examples herein will be described. FIG. 4 illustrates a process 400 for wirelessly charging an electronic device 200 which is separate from (e.g., not attached to) the base unit (e.g., base unit 100 or 300). The base unit and/or the electronic device 200 may be moved to a position, such that the base unit and electronic device 200 are proximate to each other, as shown in block 420. For example, a user may wear or carry both the base unit 100 and the electronic device 200. During this time, the electronic device 200 may be in proximity to the base unit (e.g., within the charging range of the base unit) and may wirelessly receive power from the base unit.

The base unit may be configured to selectively transmit power. For example, the base unit may be configured to preserve energy during times when electronic devices are not sufficiently close to the base unit to receive the power signals. The base unit may be configured to stop transmission of power when no compatible electronic devices are detected in proximity. The base unit may be configured to start and/or stop transmission of power if a state is detected. The base unit may be configured to alert the user when electronic device is outside of a particular range.

Prior to initiating power transmission, the base unit may detect an electronic device in proximity, e.g., as shown in block 430. The electronic device may be in proximity for charging while remaining separated by a distance from the base unit. That is, the electronic device may be in proximity for charging even though the electronic device does not contact the base unit. In some examples, the electronic device may broadcast a signal (block 410), which may be detected by the base unit. The signal may be a proximity signal indicating the presence of the electronic device. The signal may be a charge status signal, which provides also an indication of the charge level of a power cell (if any) within the electronic device. When the electronic device is within a communication range of the base unit, the base unit may detect the signal broadcast by the electronic device and may initiate power transfer in response to said signal. The communication range may be substantially the same as the charging range. In some examples, the communication range may be smaller than the charging range of the base unit to ensure that electronic devices are only detected when well within the charging range of the base unit. The electronic device may remain in proximity as long as a distance between the electronic device remains equal to or less than the threshold distance (e.g., charging range).

In some examples, broadcasting a signal from the electronic device may be impractical, e.g., if limited power is available onboard the electronic device. The base unit may instead transmit an interrogation signal. The interrogation signal may be transmitted continuously or periodically. The electronic device may be configured to send a signal (e.g., proximity signal, charge status signal, charging parameters such as but not limited to, charging frequency, power requirement, and/or coil orientation) responsive to the interrogation signal. In some examples, redundant detection functionality may be included such that both the base unit and the electronic device broadcast signals and the detection is performed according to either of the processes described with reference to blocks 405 and 410.

The base unit may wirelessly transmit power to the electronic device 200 (block 440) while one or more conditions remain true. For example, the base unit may continue to transmit power to the electronic device while the electronic device remains within the charging zone of the base unit or until the power cell of the electronic device is fully charged. With regards to the latter, the electronic device may transmit a charge status signal when the power cell is fully charged and the base unit may terminate broadcast of power signals when the fully charged status signal is detected. In some examples, alternatively or in addition to sending a fully charged status signal, the electronic device may include a charging circuit which is configured to protect the power cell of the electronic device by turning off charging once the power cell is fully charged. In this manner, an individual electronic device may stop receiving power while the base unit continues to transmit, e.g., in the event that multiple devices are being charged.

In some examples, the base unit may be configured to periodically or continuously send interrogation signals while broadcasting power signals. The interrogation signals may trigger response signals from electronic devices 200 in proximity. The response signals may be indicative of whether any electronic devices remain in proximity and/or whether any devices in proximity require power. The base unit may be configured to broadcast power until no electronic devices are detected in proximity or until all charge status signal of electronic device in proximity are indicative of fully charged status.

In some examples, the base unit may be further configured to adjust a mode of power transmission. The base unit may be configured to transmit power in a low power mode, a high power mode, or combinations thereof. The low power mode may correspond to a power transfer mode in which power is broadcast at a first power level. The high power mode may correspond to a power transfer mode in which power is broadcast at a second power level higher than the first power level. The low power mode may correspond with a mode in which power is broadcast at a body-safe level. The base unit may be configured to detect a state of the base unit, as in block 450. For example, a sensor (e.g., an accelerometer, a gyro, or the like) onboard the base unit may detect a change in the position or orientation of the base unit, or a change in acceleration, which may indicate that the base unit is being held or moved towards the user's body. The controller may be configured to determine if the base unit is stationary (block 460) and change the power mode responsive to this determination. For example, if the base unit is determined to be stationary, the base unit may transmit power in high power mode as in block 470. It the base unit is determined not to be stationary, the base unit may reduce the power level of power signals transmitted by the base unit. The base unit may change the mode of power transmission to low power mode, as shown in block 480. The base unit may continue to monitor changes in the state of the base unit and may adjust the power levels accordingly, e.g., increasing power level again to high once the base unit is again determined to be stationary. The sensor may monitor the state of the base unit such that power transmission is optimized when possible while ensuring that power is transmitted at safe levels when appropriate (e.g., when the base unit is moving for example as a result of being carried or brought into proximity to the user's body).

In some examples, the base unit may be communicatively coupled to or incorporated into an electronic device, such as a mobile phone, walkie-talkie, two-way radio, or other electronic device. The electronic device may be configured to execute a software application, which may provide a user interface for controlling one or more functions of the base unit and/or other electronic devices. For example, the software application may enable a user to configure power broadcast or interrogation signal broadcast schedules and/or monitor the charge status of the base unit and/or electronic device coupled thereto. As another example, the software application may enable a user to change a state for determining when to wirelessly transmit power, begin recording, and/or taking other actions. In some examples, the functionality of the base unit may be controlled by another party, separate from the user of the base unit (e.g., remotely-located administrators). The software application may also enable processing of data received by the base unit from the electronic device(s), such as encryption, image processing, video processing, audio processing, adding metadata (e.g., date stamping, location stamping, watermarking, authenticating, etc.).

FIG. 5 illustrates a flow chart of a process 500 for wireless power transfer in accordance with further examples herein. In the example in FIG. 5, the base unit may be communicatively coupled to a device (e.g., a mobile phone, walkie-talkie, or two-way radio), such that the device may transmit a command signal to the base unit. The command signal may be a command to initiate broadcast of interrogation signals, as shown in block 505. The base unit may transmit an interrogation signal (block 510) responsive to the command signal. Proximity and/or charge status signals may be received from one or more electronic devices in proximity (block 515). Upon detection of an electronic device in proximity, the controller of the base unit may automatically control the transmitter to broadcast power signals (block 520). In some examples, an indication of a detected electronic device may be displayed on the mobile phone display. The device may transmit a command signal under the direction of a user, which may be a command to initiate power transfer. The base unit may continue to monitor the charge status of the electronic device (e.g., via broadcast of interrogation signals and receipt of responsive charge status signals form the electronic device), as shown in block 525. Broadcast of power from the base unit may be terminated upon the occurrence of an event, as shown in block 530. The event may correspond to receiving an indication of fully charged status from the one or more electronic devices being charged, receiving an indication of depleted stored power in the battery of the base unit, or a determination that no electronic device remain in proximity to the base unit. In some example, the broadcast of power may continue but at a reduced power lever upon a determination that the base unit is in motion (e.g., being carried or moved by a user 5).

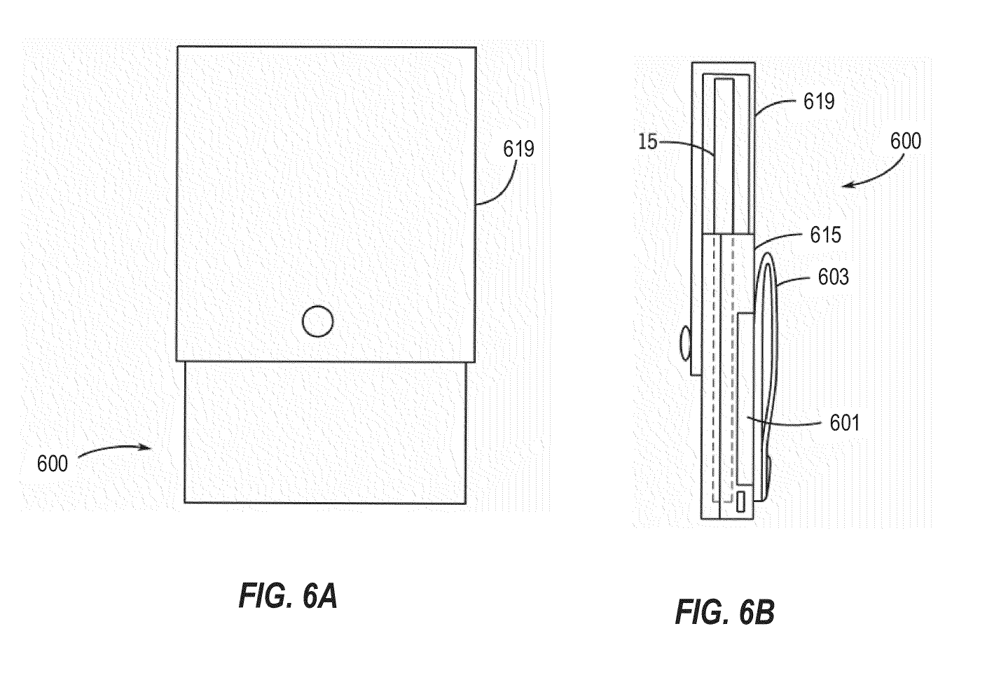

FIGS. 6A and 6B illustrate a base unit 600 having a housing 615 according to further examples herein. The housing 615 may be a partial case configured to attach to or receive a device or article 15. The device or article 15 may be a communication device (e.g., a cell phone, radio, walkie-talkie, or two-way radio), a firearm, a baton, handcuffs, a flashlight, a chemical spray device, or other device or article 15. The housing 615 may enclose the circuitry of the base unit 600. A movable cover 619 may be attached to the housing 615. The movable cover 619 may be hinged at one or more locations to allow the cover 619 to be moved out of the way to access the base unit 600 and/or the device or article 15. In some examples, an attachment member may be coupled to the housing 615, cover 619 or both. The attachment member 603 may be configured to allow the user to conveniently carry the base unit 600. For example, the attachment member 603 may be a clip, a loop or the like, for attaching the base unit to clothing or accessories, such as a duty belt. The movable cover 619 may be secured in a closed position via a conventional fastener (e.g., a snap, a magnetic closure, or others). In some embodiments, the fastener or other portions of the housing may be monitored by a sensor that determines whether the device or article 15 has been accessed or moved.

In some examples, it may be desirable to maximize the number of windings or length of wire used in the windings. A base unit having a generally flattened parallelepiped shape may have four perimeter sides (top, bottom, left and right sides) and two major sides (front and back sides). The number of windings or length of wire used in the windings may maximized by placing the windings at the peripheral portion of the device. For example, the conductive wire may be wound with the loops substantially traversing the perimeter of the base unit (e.g., as defined by the top, bottom, left and right sides. FIG. 7 illustrate examples of base units 700a-c in which conductive windings 716 are provided at the perimeter of the base unit and the core material (e.g., core rods 714) is provided in an interior portion of the base unit spaced from the windings. Base unit 700a includes individual rods 714 which are arranged with their centerlines perpendicular to a major side (e.g., front or back side) of the base unit. Base units 700b and 700c include individual rods 714 which are arranged with their centerlines arranged parallel to a perimeter side of the base unit.

FIG. 8 illustrates arrangements of transmitting coils of base units according to further examples of the present disclosure. The conductive wire may be wound such that the wire is in a plane substantially parallel to a major side of the base unit. For example, base unit 800a includes a core material in the form of a core plate 817 and windings wrapped around the core plate with the coil axis substantially parallel to the left and right sides of the base unit. Base units 800b and 800c includes windings 816 similar to the windings of base unit 800a but using discrete rods 816 as core material, the rods spaced inwardly from the windings and arranged parallel to a perimeter side of the base unit. Non-magnetic material may be provided in the spaces between the rods in the examples in FIGS. 7 and 8. Different combination of orientations of the windings and rods than the specific examples illustrated may be used in other examples.

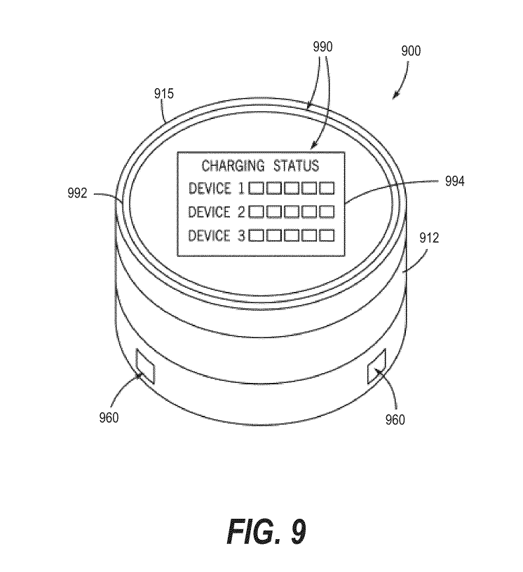

The base unit may be incorporated in a variety of shapes which may have a relatively small form factor. The base unit may be incorporated into a form factor which is portable, e.g., fits in a user's hand and/or easy to carry in the user's pocket, bag, or may be attachable to a wearable accessory of the user). For example, referring now also to FIG. 9 base unit 900 may have a housing 915 which has a generally cylindrical shape (e.g., puck shape). A puck base unit 900 may include some or all of the components of base units described herein and the description of such components will not be repeated. For example, the base unit may include a transmitter (e.g., Tx coil 912) a battery and a controller (not shown). The housing 915 may have a first major side (e.g., a base) and a second major side (e.g., a top). The Tx coil may be placed along the perimeter (e.g., proximate and extending, at least partially, along the cylindrical perimeter side) of the base unit. In some examples, the core may be in the shape of a cylindrical core plate. The coil windings, cylindrical core plate, and cylindrical puck may be coaxially aligned. The base unit 900 may include one or more input ports 960 for connecting the base unit to external power and/or another computing device. For example, the base unit 900 may include a first input port 960-1 for coupling AC power thereto and a second input port 960-2 (e.g., USB port) for coupling the base unit to a computing device, e.g., a laptop or tablet. The base unit 900 may include one or more charge status indicators 990. The charge status indicators 990 may provide visual feedback regarding the status and/or charging cycle of the base unit, the electronic devices in proximity, or combinations thereof.

A charge status indicator in the form of an illumination device 992 may be provided around the perimeter of the base unit or the perimeter of a major side of the base unit. The illumination device may include a plurality of discrete light sources. Individual ones or groups of individual light sources may provide status indication for individual electronic devices which may be inductively coupled to the base unit for charging. In some examples, an indicator display 994 may be provided on a major side (e.g., a top side) of the base unit. The indicator display may be configured to provide individual charge status indications for one or more electronic devices inductively coupled to the base unit for charging.

The indicator display 994 may be configured to display other data. For example, the electronic device 200 may be configured as a camera and the indicator display 994 may display visual images or video received from a camera, such as live or stored images. In some examples, the indicator display 994 may be configured to display data received from a sensor. In some examples, audio received from the camera or a microphone may be played back using a speaker associated with the indicator display 994.

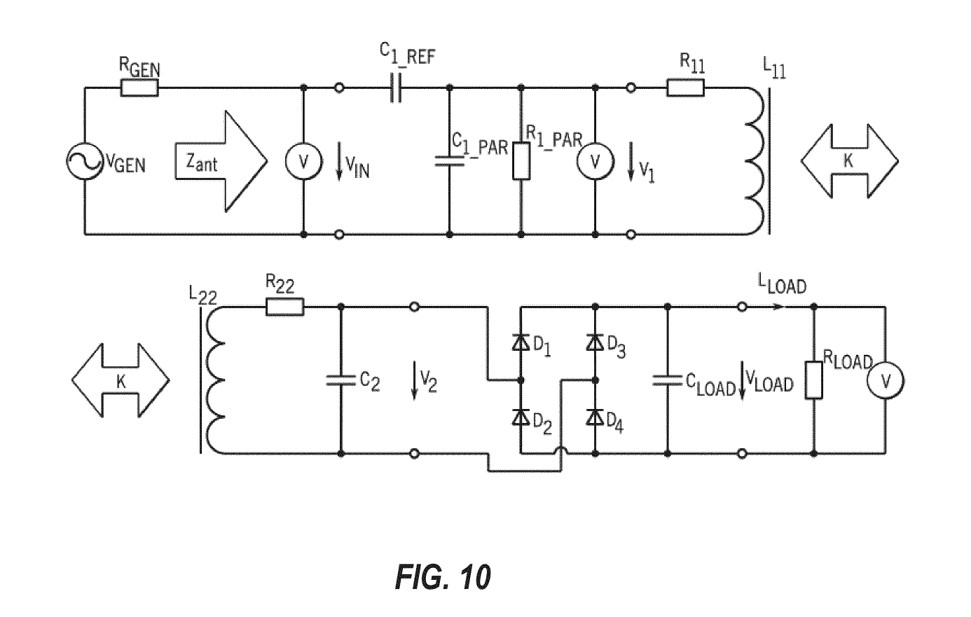

FIG. 10 illustrates components of a transmitter and receiver circuits for a wireless power transfer system in accordance with the present disclosure. On the transmitter side of the system, the transmitting coil is represented by an inductance L11. The transmitter circuit is tuned to broadcast at desired frequency. To that end, the transmitter circuit includes capacitor C1PAR and resistor R1PAR, which may be selected to tune the transmitter to the desired transmit resonance frequency. On the receiver side of the system, the receiving coil is represented by an inductance L22, and capacitor C22 and resistor R2 are chosen to tune the RLC circuit produced by the inductance of the receiving coil and C22 and R2 to the transmit resonance frequency produced by the transmitting coil. A rectifier (e.g. a full wave rectifier) is made from four diodes D1, D2, D3, and D4. The rectifier in combination with the load circuit made up for RLoad, Cload, and Lload and convert the alternating signal induced in L22 to DC voltage output for charging the battery of the device. The load resistor RLoad and the load capacitor CLoad are selected to impedance match the diode bridge to the charging circuit for the battery used in the wearable device.

In some embodiments the transmitting coil and thus the inductance L11 is relatively large compared to the inductance of the receiving coil and its inductance L22. When the transmitting and receiving coils are in close proximity the transfer efficiency is relatively high. At larger distances the efficiency is reduced but remains relatively high compared to other systems, such as a Qi standard compliant systems. This is illustrated in FIGS. 11-13.

In some examples, the shape of the pattern of a magnetic field between inductively coupled transmitting and receiving coils in accordance with the present disclosure may be largely omnidirectional with well-established nulls at the top and bottom of the coils. The radiation pattern can be directed by placing the coil against or near a reflecting ground plane to produce more of a unidirectional pattern.

FIG. 14 illustrates an example of magnetic field lines emanating from a transmitting coil and the field at the receiving coil when the position of the receiving coil is well known or predictable (e.g., in typical use scenarios). In such example, directed flux approach may be used to improve the efficiency of energy transfer.

A wireless camera system may be implemented in accordance with one or more of the embodiments described above. The system may be configured to capture visual data, audio data, geo-location data, date and time data and other data.

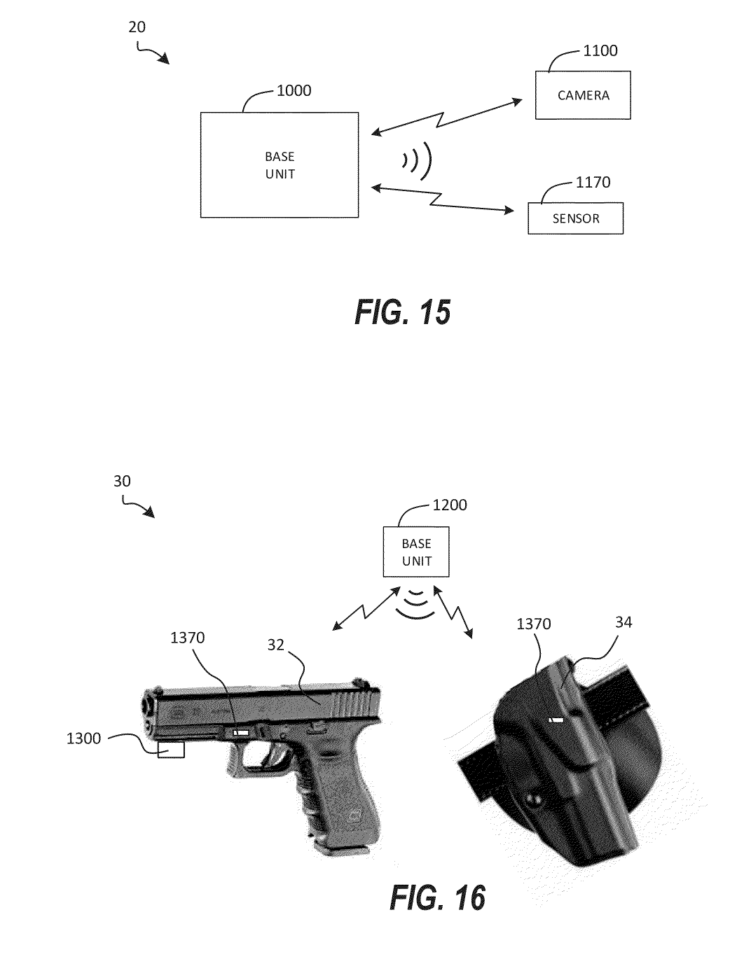

FIG. 15 illustrates an example wireless camera system 20, including a base unit 1000, a camera 1100, and a sensor 1170. The base unit 1000 may include some or all of the components and features of other base units described herein (e.g., base unit 100 or 300). The base unit 1000 may be configured to provide power to the camera 1100. In an example, the base unit 1000 is configured to provide wireless power (e.g., to the camera 1100 or another electronic device) using the components and features described with regard to other base units herein. In an example, the base unit is configured to inductively provide wireless power using any kind of inductive coupling. In an example, the base unit 1000 is configured to inductively provide power. In an example, the camera 1100 and/or the sensor 1170 may be configured to operate as stand-alone components without a base unit. In an example, the system 20 may include more than one base unit and/or more than one camera. In an example, the system 20 includes a power source configured to provide power to the base unit 1000. The power source may be implemented using a battery which may be separate from the base unit 1000. The power source may be connected to the base unit 1000 using a wired or wireless connection. The power source may be wearable by a user. The power source may include or receive energy captured by an energy harvesting device.

The camera 1100 may include some or all of the components and features of electronic devices described herein (e.g., electronic device 200) and include the capability of taking or capturing an image, video, and/or audio. In an example, the camera 1100 may be a camera with a hemispherical lens configured with a 180 degree field of view. The camera 1100 may have an optic of a rounded half bubble, similar to a bulging fly eye having 180 micro-lenses mounted on it. The camera 1100 may have a hemispherical lens that is made up of a plurality of micro-lenses. The camera 1100 may have a half ball lens, a wide angle lens. In an example, the camera 1100 may include a CMOS APS chip. By way of example, the camera 1100 may be configured to take still photos, record video images, infrared images, sonic images (such as an ultra sound camera), radiation images, thermal images, x-ray images, and/or spectrally multiplexed images. In an example, the camera 1100 may be or include a microphone configured to record, omni-directional audio, bi-directional audio, directional audio, cardioid-pattern audio, and/or other kinds of audio.

The camera 1100 may located within or have a housing configured to be attached to various articles or devices, such as a belt, a firearm, a flashlight, a light, a band, a strap, an ear, a ring, a hat, a necklace, a watch, a bracelet, headgear, an article of clothing, and/or other articles or devices. The camera 1100 can be supported by eyewear. The camera 1100 can be embedded in or attached to an frame of the eyewear, a front of the eyewear, the temple of the eyewear, and/or an optic of the eyewear. The camera 1100 can be supported by the optic of the eyewear. In an example, the camera 1100 may be connected to a fixed structure, such as a ceiling, a security pole, a light pole, a light, a pole, a wall, a desk, and/or a table. The camera system may be connected to a portion of a vehicle, such as a dashboard, a hood, a rear, an interior, or another location.

The camera 1100 may have a smaller form factor than conventional cameras by one or more of: reducing the size of a battery, eliminating the battery, eliminating a Bluetooth transceiver, reducing an amount of memory storage of the camera, eliminating a micro USB or other port, utilizing a camera on a chip (ASIC), utilizing a capacitor, and/or adding a coil. The capacitor (which can be a super capacitor) can be powered wirelessly from a base unit by way of wireless energy transfer as needed while the camera 1100 is being used.

The camera 1100 may be configured to be powered remotely by the base unit 1000, receive data from the base unit 1000, and/or transmit data to the base unit 1000. The camera 1100 and base unit 1000 may comprise one or more resonance circuits for transmitting and receiving data. The camera 1100 may be configured to have a volume of less than 1,000 mm³ or less than 500 mm³ and configured to capture 1,000 images. The camera 1100 may be configured to capture 1 hour or more of video and/or audio. The camera 1100 and base unit 1000 may be separated by 0.5 inches, 1 foot, 2 feet, 3 feet, 4 feet or greater. The camera 1100 can be located within or attached to an article or a device. The base unit 1000 and camera 1100 may be configured to communicate by way of wireless or direct connection. The communication can be that of wireless power or energy transfer. In an example, the camera 1100 may include on-board memory storage and may have less on-board memory storage capacity than that of the base unit 1000. In an example, the camera 1100 may include a battery and have less battery capacity than the base unit 1000.

The camera 1100 may be configured to wirelessly receive and/or transmit data. For example, the camera 1100 may wirelessly receive instructions (e.g., a command to start or stop recording), updates, or other data from the base unit 1000. In an example, the camera 1100 may be configured to send recorded data (e.g., images, audio, and/or video) to the base unit 1000. The camera 1100 may utilize compression algorithms to reduce the size of data to be transferred. The camera 1100 may buffer data periodically (e.g., as needed) while collecting image, video, and/or audio data. For example, the camera 1100 may record data to a buffer and then transfer the data from the buffer to the base unit 1000. In an example, the camera 1100 does not include long-term storage for recorded data and instead uses temporary buffers, as needed, to facilitate the transfer of recorded data to the base unit.

The base unit 1000 may be configured to communicate with the camera 1100 using a very narrow communication protocol which allows power and data transfer over a greater distance. The base unit can also utilize a standard communication protocol for communicating with devices other than the camera 1100. The camera 1100 may be configured to utilize a very narrow communication protocol which allows for very power efficient wireless power and data transfer. The camera 1100 may be configured to use its own communication architecture and protocol that is unique for the camera 1100. In some examples, components of the system may communicate via RF Link. The base unit may utilize its own communication architecture and protocol which is unique for the base unit and the camera 1100 communicates with the base unit. In certain embodiments the architecture of the base unit and the camera 1100 could be a simplified version of standard architecture; such as Bluetooth and Wi-Fi. The camera 1100 can utilize a non-standard architecture and protocol. The camera 1100 can comprise an ASIC. The ASIC can utilize its own communication protocol that is unique for the ASIC. The camera 1100 can comprise at least one coil which can be separated by distance and resonant coupled to at least one coil of the base unit. A repeater can be utilized, if needed, in assisting communication between the two separated resonant coupled coils of the camera 1100. The resonant coupled efficiency of the two separated resonant coupled coils can have an efficiency below that of 80%, 70%, 60%, 50%, 40%, 30%, 20%, 10% or lower, which may still provide the appropriate wireless power transfer due to low power needs of the camera 1100. The distance between the two separated resonant coupled coils can be less than 3 inches, 6 inches, 12 inches, 24 inches, 36 inches, more than 36 inches or another distance.

In an example, the camera 1100 and the base unit 1000 are separated by 12 inches or more, and the camera 1100 is configured to wirelessly transmit an image using 100 microwatts of power or less to the base unit 1000 and the base unit 1000, after factoring in the loss of efficiency, receives the image transmitted from the camera 1100. In an example, the camera 1100 is configured to operate on 1 watt of power or less, the base unit is configured to transmit 10 watts or less of wireless power to the camera and whereby the camera upon receiving the net wireless power from the base unit and after factoring in the loss of efficiency is capable of taking an image.

A camera module may provide functionality for the camera 1100. The camera module may comprise a switch, a power source, a sensor, memory, a controller, a microprocessor, a microphone, an audio processor, a video sensor, a video processor, an image sensor, an image processor, a micro-USB port, and/or an LED. In certain embodiments the camera module can be integrated within the camera 1100. In other examples the camera module is separate from but electrically connected to the camera 1100. The camera module can further comprise a coil (such as a Tx coil 112 or a Rx coil 212). The camera module may include an energy harvesting device, such as a solar cell, to supplement or replace the power received from the base unit.

The system 20 can comprise multiple cameras 1100. In an example, the multiple cameras may be arranged to provide a 360-degree view. For example, there may be three 120-degree field of view cameras, four 90 degree field of view cameras, five 72-degree field of view cameras, six 360-degree field of view cameras, or other types and arrangements of cameras. Multiple cameras can share or utilize common coils, common memory storage, a common microphone, a common sensor, a common ASIC, a common backup battery, a common base unit, or other resources. In an example, the plurality of cameras utilize a common coil that is resonant coupled to a coil of a remote base unit. In an example, each of the plurality of cameras can communicate using a unique frequency or frequency modulation.

The sensor 1170 may include some or all of the components and features of an electronic device described herein (e.g., electronic device 200). The sensor 1170 may be configured to communicate directly or indirectly with the camera 1100 and/or base unit 1000 using a wireless or wired connection. The sensor 1170 may be configured to detect a state and/or a condition and store or transmit the results. The sensor 1170 may or may not be wirelessly powered from the base unit 1000. In an example, the sensor 1170 and the camera 1100 are located within the same housing.

In an example, the system 20 may include a light (e.g., a flashlight or a flash associated with the camera), a range finder, a laser, a microphone, a holster, a firearm, an audio recorder, and/or other articles or devices. The articles or devices may be or comprise an electronic device 200. In an example, a firearm may comprise a laser sight. The base unit 1000 may wirelessly charge and/or communicate with one or more of these components. One or more of these features may be integrated into the camera 1100, the base unit 1000, and/or it may be a separate component. In an example, a component may be configured to turn on and/or start recording when another electronic device is turned on or activated. For example, an audio recording may begin when the camera 1100 begins recording.

The systems and methods described herein (such as system 20), may find applications in police, military, and/or security forces, such as with firearms, holsters, utility belts, hats. Systems and methods described herein may be used with a duty belt or other wearable device for holding or storing devices. Devices worn or stored on a duty belt may include a radio, a walkie-talkie, handcuffs, chemical sprays, flashlights, ammunition, a baton, disposable gloves, a knife, a multi-tool, a first aid kit, a notebook, and/or other items. In some examples, the duty belt may include a sensor for determining when an item of the duty belt is accessed.

FIG. 16 illustrates an example wireless camera system 30, including a firearm 32, a holster 34, a base unit 1200, a camera 1300, and a sensor 1370. The base unit 1200 may include some or all of the components and features of other base units described herein (e.g., base unit 100, 300, or 1000). The base unit 1200 may be integrated with and/or coupled to the holster 34 in some examples. In an example, the base unit 1200 may be worn on a duty belt. The camera 1300 may include some or all of the components and features of other cameras described herein (e.g., camera 1100). The sensor 1370 may include some or all of the components and features of other sensors described herein (e.g., sensor 1170).

The firearm 32 may be a weapon configured to launch any kind of projectile. The firearm 32 need not be limited to gunpowder-based firearms or lethal weapons. In an example, the firearm 32 may include non-lethal weapons, less-than-lethal weapons, or other devices, such as an airfoil gun, a beanbag gun, an electroshock weapon, a chemical agent (e.g., pepper spray, tear gas, and/or mace) dispersant, a laser-based weapon, an acoustic-based weapon, and/or other devices. The holster 34 may be a device for holding or storing a weapon, such as the firearm 32. The holster 34 may maintain the device in a stored configuration. In an example, the holster 34 may be a firearm holster, such as the one illustrated in FIG. 16. In an example, the holster 34 may be, a firearm rack, a firearm safe, a firearm scabbard, a strap, a pocket, cover and/or any other kind of device or housing for holding, storing, or stowing a firearm or weapon. In an example, the holster 34 may include the base unit 1200.

In an example, the camera 1300 is mounted to an underside of the firearm 32. In another example, the camera 1300 may be configured to be mounted or attached to various portions of the firearm 32, including but not limited to: a slide, a barrel, a trigger guard, a grip, a magazine, a sight, a forestock, a muzzle, a front-grip, a hand guard, a mounting rail (e.g., a NATO accessory rail), or other components. In another example, the camera 1300 may be mounted to an existing accessory of the firearm 32, such as a mounted flashlight or laser sight. The placement of the camera may be selected so as not to interfere with the operation of the firearm 32. In an example, the camera 1300 receives power from a power source of the firearm 32. For example, the power source may be a power source for an accessory of the firearm 32 (e.g., a flashlight, laser sight, or other accessory) or for the firearm 32 itself (e.g., when the firearm 32 is an electroshock weapon).

In an example, the sensor 1370 is a sensor configured to detect a state of the firearm 32. The sensor 1370 may be a component of the camera 1300, associated with the camera 1300, and/or separate from the camera 1300. In an example, the sensor 1370 may be located on the firearm 32, the holster 34, or in other locations. The sensor 1370 may be configured to detect whether the firearm 32 is within a holster 34 or is otherwise in a stowed position. In an example, the sensor 1370 is a photosensor or a UV sensor that is blocked from receiving light when the firearm 32 is stored but receives light when the firearm 32 is in the open. The sensor 1370 may be a separation sensor that detects whether the sensor 1370 is separated from or near a component located on or near a holster 34. In an example, the firearm 32, the camera 1300, and/or the sensor 1370 may be configured to wirelessly receive power when the firearm 32 is stored in the holster, and the sensor may be configured to detect whether the firearm 32, the camera 1300, and/or the sensor 1370 is receiving power (e.g., inductively or conductively) from an external source, such as the base unit 1200. In an example, the camera 1300 is configured to record data when the camera is not receiving power. The sensor 1370 may be a movement-sensor that detects a pattern of movement associated with a firearm 32 being moved out of a holster 34 or otherwise out of a stowed position. In another example, the sensor 1370 may be configured to detect whether the firearm 1370 is moved into a ready position. For example, the sensor 1370 may be configured to detect when the firearm 32 is being gripped, when a finger is near the trigger of the firearm 32, when a stock of the firearm 32 is against a user's body, and/or other states. In another example, the sensor 1370 may be configured to detect whether the firearm 32 has been discharged. The sensor 1370 may be configured to detect vibrations, acceleration, noise, or other conditions associated with discharge of the firearm 32. In another example, the sensor 1370 may be configured to detect whether a safety of the firearm 32 has been deactivated.

The holster 34 may be configured with one or more sensors 1370 to detect a state of the holster 34 or a device disposed within the holster, such as the firearm 32. The state may include whether the firearm 32 is disposed within the holster 34, whether a strap keeping a firearm 32 in place is secured, whether the holster 34 is being worn, or other states. The holster 34 and/or a base unit 1200 may be configured to wirelessly charge a component of the firearm 32 (e.g., a flashlight, a camera, a laser sight, biometrics, microcomputer, and/or other features or accessories of the firearm 32) while the firearm 32 is holstered.

Based on a state detected by the sensor 1370, the base unit 1200 may change a parameter and/or take an action. For example, the action may be to power a particular electronic device or to send a signal to cause the electronic device to begin recording. In an example, the base unit 1200 may charge an electronic device using a first charging method when the device is in or near the holster 34 and using a second charging method when the device is away from the holster 34 but still within a charging range. The base unit 1200 may be configured to automatically provide power to the camera 1300 when the firearm 32 leaves the holster 34. The camera 1300 may be configured to automatically begin recording and transmit recorded data when it receives power. The camera 1300 may be configured to include a rechargeable battery and the camera may be configured to turn on automatically based on a sensor. The camera 1300 may be configured to begin or end recording based on whether the firearm 32 is in a stored configuration, such as when the firearm 32 is stored within the holster 34.

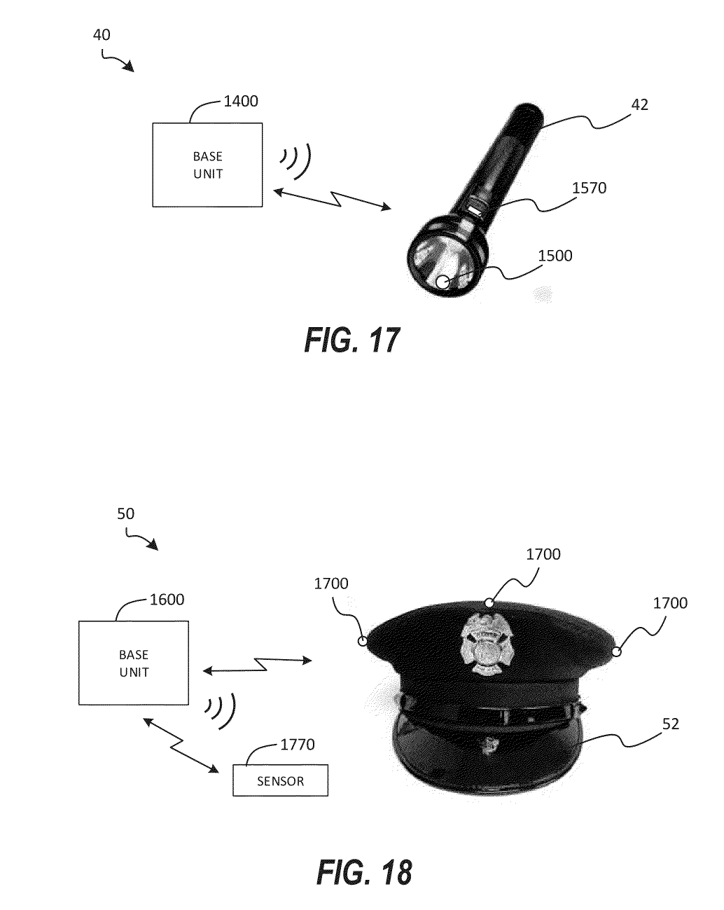

FIG. 17 illustrates an example system 40, including a flashlight 42, a base unit 1400, a camera 1500, and a sensor 1570. The base unit 1400 may include some or all of the components and features of other base units described herein (e.g., base unit 100, 300, 1000, or 1200). The camera 1500 may include some or all of the components and features of other cameras described herein (e.g., camera 1100 or 1300). The sensor 1570 may include some or all of the components and features of other sensors described herein (e.g., sensor 1170 or 1370). In an example, the system 40 does not include the base unit 1400.

The flashlight 42 may be a handheld, gun-mounted, wearable (e.g., on a shoulder or on the head), and/or another kind of flashlight configured to provide light. In an example, the flashlight 42 may be only one of or both of a flashlight configured for use by a user to illuminate an area (e.g., a police issue flashlight) and an illumination source configured to support the recording of a camera by providing light (e.g., a camera flash or a spot light for recording). In an example, the flashlight 42 is inductively coupled to and receives power from the base unit 1400. In an example, the flashlight 42 is configured to inductively or conductively receive power when in a stored position (e.g., when the flashlight 42 is worn on a belt). In an example, the flashlight's power source may charge a base unit and/or a camera. The flashlight may include or support a base unit (e.g., base unit 1400).

The camera 1500 may be disposed on an exterior surface of the flashlight 42, be incorporated into the light source of the flashlight 42, be located in an area between the light sources of the flashlight 42 (e.g., between LED lighting elements of the flashlight 42), be located on a glass of the flashlight 42, or in other areas. In an example, the camera 1500 may be located in an area so as not to block or not to substantially block the light emitted from the flashlight 42. The camera 1500 and/or flashlight 42 may be configured so the light from the flashlight 42 does not substantially interfere with the quality of the image produced by the camera 1500. In an example, the camera 1500 is configured to operate without a base unit. The camera 1500 may be configured to receive power through a wired or wireless connection to the power source of the flashlight 42.

The sensor 1570 may be configured to detect or determine whether the flashlight 42 is on or off. The sensor 1570 may be electrically coupled to the flashlight 42 and/or separated from the flashlight 42. The sensor 1570 may be a photosensor configured to determine whether the flashlight 42 is producing light, the sensor 1570 may be disposed over or connected to a button or switch used to turn the flashlight 42 on or off and be configured to be sense when a user turns on the flashlight 42. In an example, the sensor 1570 is configured to operate without a base unit. The sensor 1570 may be configured to receive power from the power source of the flashlight 42.

FIG. 18 illustrates an example wireless camera system 50, including headgear 52, a base unit 1600, cameras 1700, and a sensor 1770. The headgear 52 may be any kind of article worn on the head, including but not limited to a hat, a helmet, goggles, glasses, or other headgear. The headgear 52 may include an energy harvesting device (such as solar chargers). In an example the headgear 52 is a peaked cap traditionally worn by police officers. The base unit 1600 may include some or all of the components and features of other base units described herein (e.g., base unit 100, 300, 1000, 1200, or 1400). The cameras 1700 may include some or all of the components and features of other cameras described herein (e.g., camera 1100, 1300, or 1500). The sensor 1770 may include some or all of the components and features of other sensors described herein (e.g., sensor 1170, 1370, or 1570). The headgear 52 may be a platform on which the cameras 1700 are located. The cameras 1700 may be located on different portions of the headgear 52, such as a left side, top side, right side, back side, or other locations (e.g., a brim of a hat). In an example, there are cameras 1700 that are facing forward, temporally, rearwardly, and/or in other directions. The cameras 1700 may be configured or arranged to provide a view approximating at what the wearer of the headgear 52 is looking.

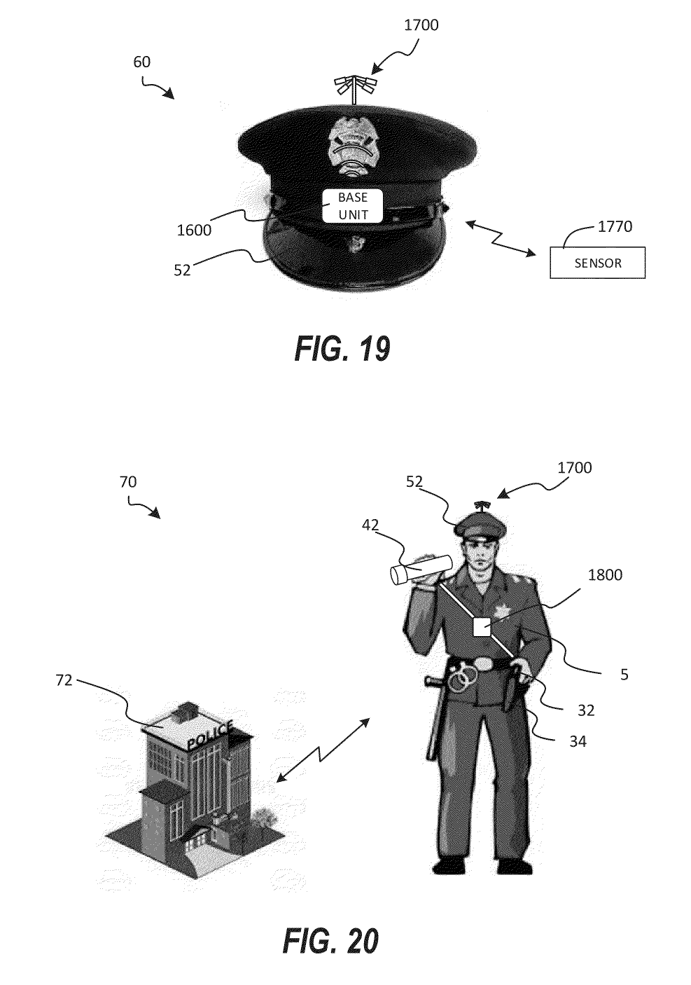

FIG. 19 illustrates an example wireless camera system 60, including headgear 52, a base unit 1600, cameras 1700, and sensor 1770. The headgear 52 may include an antenna that is connectable to the cameras 1700. In the system 60, the base unit 1600 is a part of the headgear 52. In an example, the base unit is attached to a front portion of the headgear 52. The base unit may be located in other locations, such as at a brim of the headgear 52, at a strap of the headgear 52, at an interior area of the headgear, or in other locations. The cameras 1700 may be arranged on a single structure mounted on the headgear 52.

FIG. 20 illustrates an example wireless camera system 70, including a user 5, a firearm 32, a holster 34, a flashlight 42, headgear 52, cameras 1700, and a base unit 1800. The base unit 1800 may include some or all of the components and features of other base units described herein (e.g., base unit 100, 300, 1000, 1200, 1400, or 1600). In an example, the base unit may be worn on a strap passing diagonally over the right should of the user 5. The system 70 also includes a remote, other party 72. The other party 72 may include a supervisor, an administrator, a server, a computer, nearby security personnel, a dispatcher, or other parties. In an example, the party 72 may receive information from the cameras 1900 and sensors worn by the user 5. The information may be live or delayed. The base unit 1800 may include a cellular radio, Wi-Fi antenna, or other component configured to communicate to the remote party 72. The base unit 1800 may be configured to store the information until it reaches a particular location (e.g., an area with an internet connection) and then automatically or manually transmit the information to the party 72.

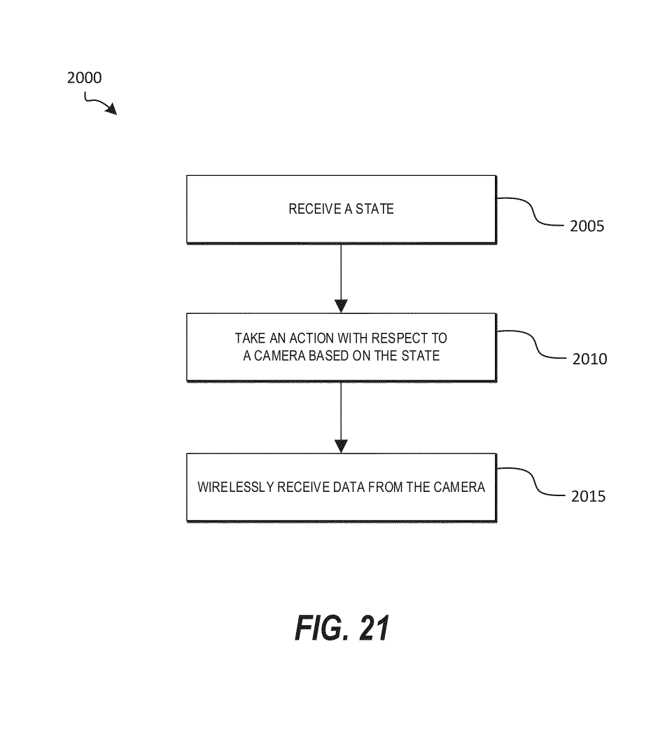

FIG. 21 illustrates a flow chart of a process 2000 involving a base unit, sensors, and a camera in accordance with examples herein. In the example in FIG. 21, a base unit may receive a state from a sensor, as shown in block 2005. The state may be a state in response to which a user desires recording to begin or end. The sensor may be a sensor mounted to a device, such as a firearm or flashlight. In an example, the sensor may detect a state of a device, such as that a firearm has been removed from a holster, that a firearm has been returned to the holster, that a firearm is in the holster, that a firearm was readied for firing, that a firearm had its safety turned off, that a firearm had its safety turned on, and/or that a firearm has been discharged. In another example, the sensor may detect a state of a flashlight, for example, that the flashlight has been turned on, that the flashlight is running low on power, that the flashlight has no more power, that the flashlight has been turned off, or other states. In an example, the state may be a state of a user, such as a heart rate, blood pressure, a temperature of the user, or other states. In another example, the state may be the state of an environment, such as temperature, noise, humidity, toxicity, or other states of an environment. In another example, the state may be the state of a vehicle, such as speed, acceleration, deceleration, location, or other states. In an example, the sensor is configured to detect an indication from a user or another party that recording should begin. For example, the sensor may detect a state indicating that a button has been pushed, a switch has been flipped, a voice command given, or other such indication. In an embodiment, the base unit may transmit an indication of the state to another party. For example, the base unit may receive a state indicating that a firearm is out of a holster and the base unit may transmit an indication of this state to another party. The indication may include metadata regarding the event, including but not limited to the location of the event, information of a user associated with the state (e.g., a user associated with the firearm), and/or other information.

The base unit may take an action with respect to a camera based on the state, as in block 2010. In an example, the base unit may transmit power to the camera responsive to the state. For example, the base unit may transmit power to the camera responsive to a state indicating that a firearm to which the camera is attached is in a holster. As another example, the base unit may transmit power to the camera responsive to a state indicating that an event should be recorded. In an example, the camera may be instructed to record data responsive to the state. For example, a base unit or a sensor may cause a camera to record responsive to a state indicating that a firearm is out of a holster, that a flashlight is turned on, or there is a likelihood of an event of interest occurring. In an example, the base unit may transmit power to the camera responsive to a state or a combination of states meeting certain rules. In an example, the camera may be instructed to begin recording responsive to a heart rate sensor detecting that a user's heart rate is elevated by 25% compared to a baseline for longer than ten seconds. In some examples, the camera may already be receiving power (e.g., from a rechargeable battery) and the camera receives an instruction to begin recording, stop recording, turn on, turn off, save recordings, stop saving recordings, or another instruction responsive to the state. In an example a camera has power and is operating in a first power mode (e.g., a low power mode) and then switches to a second power mode (e.g., a higher power mode) responsive to the state. In the first power mode, for example, the camera may be operating in a standby, non-recording mode, and in the second power mode, the camera may be operating in a recording mode. The camera may switch from the first power mode to the second power mode responsive to receiving additional power from base unit, and/or receiving a command. In an example, the camera is a camera located on the device of which the state was received. For example, the state may have been collected from a sensor on a firearm and the base unit may transmit power to a camera on a firearm. In an example, the base unit may transmit power or an instruction to record to all available cameras. For example, the base unit may receive a state indicating that a flashlight has been turned on and then wirelessly transmits power to cameras located on headgear, a firearm, and the flashlight.

The base unit may wirelessly receive data from the camera, as in block 2015. In an example, the camera may record data and transmit the data to the base unit while it is receiving power and/or while it is instructed to record and transmit. In an example, the camera stores data until a later event. For example, the camera may record and store data until the camera is in close proximity to the base unit or a receiver (e.g., because the firearm has been returned to a holster). In an example, the base unit receives an indication that a firearm has been removed from a holster. In response, the base unit may transmit power and/or an instruction to record to a camera, which begins recording. In an example, the camera is configured to record or instructed to record based on a sensor. The sensor may provide an indication that the firearm is no longer in a stored configuration in the holster. In an example, the base unit and/or the camera transmits or relays the received data to a remote party for storage, backup, review, or viewing. In an example, metadata is collected regarding the received data. For example, timestamp and/or geo-location data may be collected. In another example, information about the user associated with the camera and/or base unit is collected.

By careful specification of the use cases for the charging system of the wearable device, a wireless power transfer system can be optimized to produce an improved arrangement of charging conditions while preserving form factor through a reduction of battery size needed to normally charge a device for its typical use period between charging cycles. In some applications, the electronic device may not need to be intentionally placed in a manner to facilitate charging, since the power transmitted at the use case distance may be adequate for maintaining the energy draw from the system on the battery.

The above detailed description of examples is not intended to be exhaustive or to limit the method and systems to the precise form disclosed above. While specific embodiments of, and examples for, the method and systems for wireless power transfer are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. It will be further appreciated that one or more components of base units, electronic devices, or systems in accordance with specific examples may be used in combination with any of the components of base units, electronic devices, or systems of any of the examples described herein.

What is claimed is:

1. A firearm comprising:
a camera attached to the firearm and configured to receive power when the firearm is in a stored configuration; and
a sensor electrically coupled to the camera and configured to detect whether the firearm is in the stored configuration,
wherein, the camera is configured to record data responsive to the sensor detecting the firearm is not in the stored configuration.

2. The firearm of claim 1, wherein the camera is configured to cease recording data responsive to the sensor detecting the firearm is in the stored configuration.

3. The firearm of claim 1, wherein the camera comprises a receiver configured to receive energy.

4. The firearm of claim 1, wherein the stored configuration comprises the firearm being secured by a holster, a firearm rack, a firearm safe, a firearm scabbard, a strap, a cover, a pocket, or a housing for the firearm.

5. The firearm of claim 1, wherein the sensor is a UV sensor, a photosensor, a pressure sensor, or a motion sensor.

6. The firearm of claim 1, wherein the camera attached to the firearm is configured to inductively receive power when the firearm is in a stored configuration.

7. The firearm of claim 1, wherein the camera attached to the firearm is configured to receive power by way of wireless power transfer or energy harvesting.

8. The firearm of claim 1, wherein the camera comprises a rechargeable battery or a capacitor.

9. A firearm holster comprising:
a transmitter configured for wireless power delivery to a camera mounted on a firearm configured for placement in the firearm holster;
a power source coupled to the transmitter, the power source comprising a battery or a port configured to receive power;
a controller coupled to the power source and the transmitter, wherein the controller is configured to cause the transmitter to selectively transmit power from the power source to the firearm when the firearm is placed in the firearm holster;
a receiver configured to receive sensed data from the camera; and
memory configured to store the received, sensed data.

10. The firearm holster of claim 9, wherein the transmitter and the receiver are integrated in a transceiver.

11. The firearm holster of claim 9, wherein the firearm holster is configured to maintain the firearm in a stored configuration and comprises, a firearm rack, a firearm safe, a firearm scabbard, a strap, a cover, a pocket, or a housing for the firearm.

12. The firearm holster of claim 9, further comprising a housing enclosing the transmitter, the power source, the controller, the receiver, and the memory, and wherein the housing is coupled to the firearm holster.

13. The firearm holster of claim 9, wherein the transmitter comprises a coil comprising a magnetic core.

14. The firearm holster of claim 13, wherein the coil of the transmitter is inductively coupled to a coil of the camera when the firearm is placed in the firearm holster.

15. The firearm holster of claim 9, wherein:
the receiver is further configured to receive a signal from a sensor; and
the controller is configured to cause the transmitter to selectively transmit power from the power source to the camera responsive to the received signal.

16. The firearm holster of claim 15, wherein the sensor is a heartrate sensor, a photosensor, a thermal sensor, an O2 sensor, a CO sensor, a CO2 sensor, an air quality sensor, a radiation sensor, a UV sensor, a pressure sensor, a motion sensor, or an accelerometer.

17. The firearm holster of claim 15, wherein the sensor is configured to detect whether the firearm is in the firearm holster.

18. Headwear comprising:
a transmitter configured for wireless power delivery to a camera mounted on the headwear;
a power source coupled to the transmitter, the power source comprising a battery or a port configured to receive power;
a controller coupled to the power source and the transmitter and configured to cause the transmitter to selectively transmit power from the power source to the camera;
a receiver configured to receive sensed data from the camera; and
memory configured to store the received, sensed data.

19. The headwear of claim 18, further comprising a housing enclosing the transmitter, the power source, the controller, the receiver, and the memory, and wherein the housing is coupled to the headwear.

20. The headwear of claim 18, wherein the headwear comprises a hat or a helmet.

21. The headwear of claim 18, wherein the coil of the transmitter is inductively coupled to a coil of the camera.

22. The headwear of claim 18, wherein:
the receiver is further configured to receive a signal from a sensor; and
the controller is configured to cause the transmitter to selectively transmit power from the power source to the camera responsive to the received signal.

23. The headwear of claim 22, wherein the sensor is a heartrate sensor, a photosensor, a thermal sensor, an O2 sensor, a CO sensor, a CO2 sensor, an air quality sensor, a radiation sensor, a UV sensor, a pressure sensor, a motion sensor, or an accelerometer.

24. A method comprising:
receiving, at a base unit, a state of a device remote from the base unit;
responsive to the state of the device, wirelessly transmitting instructions to begin recording from the base unit to a camera mounted to the device; and
wirelessly receiving data from the camera at the base unit.

25. The method of claim 24, wherein the device is a flashlight and the state comprises the flashlight producing light.

26. The method of claim 24, wherein the device is a firearm and the state comprises the firearm being away from a holster.

27. The method of claim 24, further comprising transmitting the data from the base unit to another party.
